(19) United States
(12) Patent Application Publication
(10) Pub. No.: US 2026/0238400 A1
(43) Pub. Date: Aug. 13, 2026

(54) HARQ OVERHEAD REDUCTION

(71) Applicant: InterDigital Patent Holdings, Inc., Wilmington, DE (US)

(72) Inventors: Nazli Khan Beigi, Longueuil (CA); Young Woo Kwak, Woodbury, NY (US); J. Patrick Tooher, Montreal (CA); Yugeswar Deenoo Narayanan Thangaraj, Chalfont, PA (US); Janet A. Stern-Berkowitz, Little Neck, NY (US); Moon-il Lee, Melville, NY (US); Tejaswinee Lutchoomun, Montreal (CA); Oumer Teyeb, Montreal (CA); Prasanna Herath, Laval (CA); Haseeb Ur Rehman, Winnipeg (CA)

(73) Assignee: InterDigital Patent Holdings, Inc., Wilmington, DE (US)

(21) Appl. No.: 19/156,672

(22) PCT Filed: Feb. 14, 2024
(86) PCT No.: PCT/US2024/015665

§ 371 Date: Aug. 14, 2025

Related U.S. Application Data
(60) Provisional application No. 63/445,554, filed on Feb. 14, 2023.

(51) Int. Cl. H04L 1/1867; H04B 7/06; H04B 17/318

(52) U.S. Cl. CPC H04L 1/1896; H04B 7/0626; H04B 17/328

(57) ABSTRACT

Disclosed herein are systems, methods, and instrumentalities associated with HARQ feedback overhead reduction. A wireless transmit/receive unit (WTRU) may transmit a first type of HARQ feedback to a network device. The WTRU may then determine, based on a measurement or prediction made by the WTRU, that a condition for using a second type of HARQ feedback is met. The WTRU may send a first message to the network device, wherein the first message may indicate that the condition for switching to the second type of HARQ feedback is met. The WTRU may receive a second message from the network device in response to the first message, wherein the second message may include an indication for the WTRU to use the second type of HARQ feedback. The WTRU may then transmit a HARQ feedback of the second type based on the second message received from the network device.

### CROSS-REFERENCE TO RELATED APPLICATIONS

This application claims the benefit of U.S. Provisional Application No. 63/445,554, filed Feb. 14, 2023, the contents of which is incorporated by reference herein.

### BACKGROUND

Artificial Intelligence (AI)/Machine Learning (ML) models may be trained for improving the performance of a wireless communication system. A wireless transmit/receive unit (WTRU) may use these pre-trained AI/ML models for aspects of beam management such as beam prediction, beam selection, etc. The WTRU may also perform conventional measurements on channel conditions, beam and/or environment changes, link-adaptation parameters, etc. Therefore, it may be desirable to utilize the predictions and/or measurements made by the WTRU to further improve the performance of the wireless communication system, for example, with respect to hybrid automatic repeat request (HARQ) feedback.

### SUMMARY

Disclosed herein are systems, methods, and instrumentalities associated with hybrid automatic repeat request (HARQ) feedback overhead reduction. A wireless transmit/receive unit (WTRU) may be configured to transmit a first type of HARQ feedback to a network device. The WTRU may (e.g., subsequently) determine, based on a measurement or prediction made by the WTRU, that a condition for using a second type of HARQ feedback is met. Based on such a determination, the WTRU may send a first message to the network device, wherein the first message may indicate that the condition for switching to the second type of HARQ feedback is met. In response to sending the first message, the WTRU may receive a second message from the network device that may include an indication for the WTRU to use the second type of HARQ feedback, and the WTRU may transmit a HARQ feedback of the second type based on the second message received from the network device.

In examples, the first type of HARQ feedback may include a transport block (TB) based HARQ feedback, and the second type of HARQ feedback may include code block group (CBG) based HARQ feedback or a hybrid of TB-based and CBG-based HARQ feedback.

In examples, the condition for using the second type of HARQ feedback is associated with at least one of a reference signal received power (RSRP), a signal to noise ratio (SNR), or a channel quality indicator (CQI) measured or predicted by the WTRU based on a reference signal. In examples, the first message may include a channel state information (CSI) report and the CSI report may include a measurement result indicating that the condition for switching to the second type of HARQ feedback is met. In examples, the first message may further indicate a time duration for using the second type of HARQ feedback.

In examples, the second message may be received by the WTRU via downlink control information or a medium access control (MAC) control element (CE). In examples, the second may further indicate a time duration for using the second type of HARQ feedback and, subsequent to receiving the second message, the WTRU may determine that the time duration for using the second type of HARQ feedback has expired and send a third message to the network device indicating that the time duration has expired. In examples, the WTRU may be further configured to determine that the condition for using the second type of HARQ feedback is no longer valid and to send a third message to the network device that indicates that the condition for using the second type of HARQ feedback is no longer valid.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow diagram illustrating an example of dynamic HARQ feedback type switching.

FIG. 3 is a flow diagram illustrating an example of a WTRU requesting a HARQ type change.

FIG. 4 is a diagram illustrating example contents of a HARQ codebook as described herein.

### DETAILED DESCRIPTION

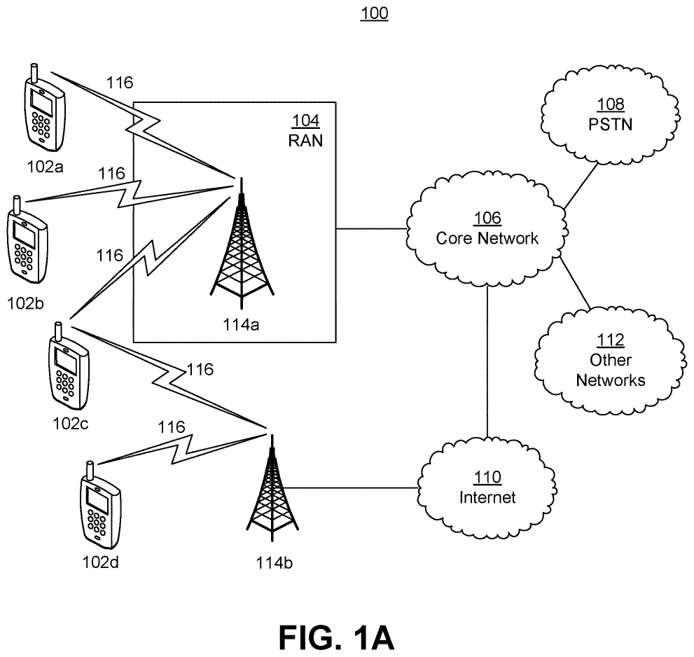

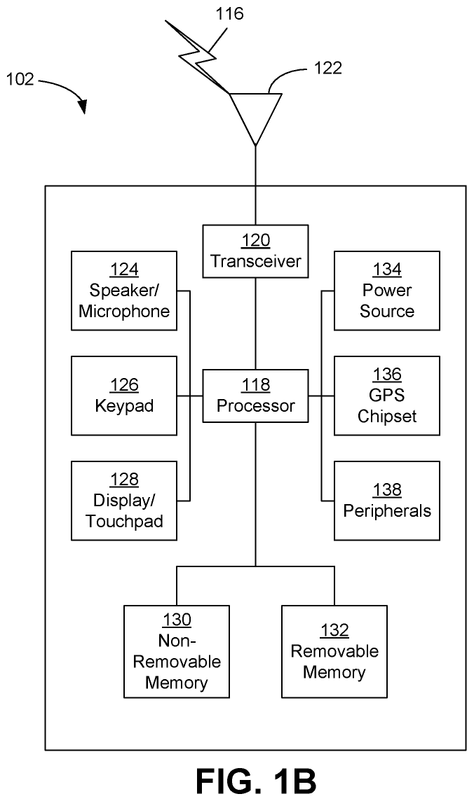

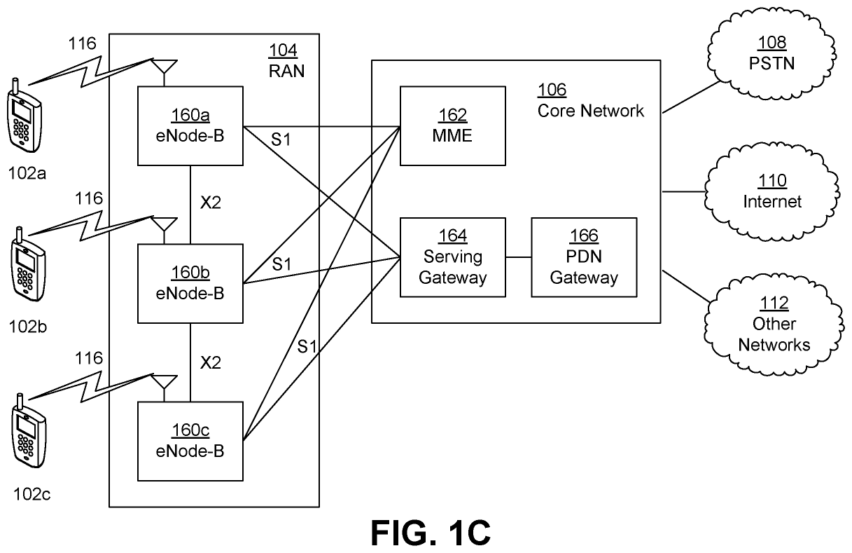

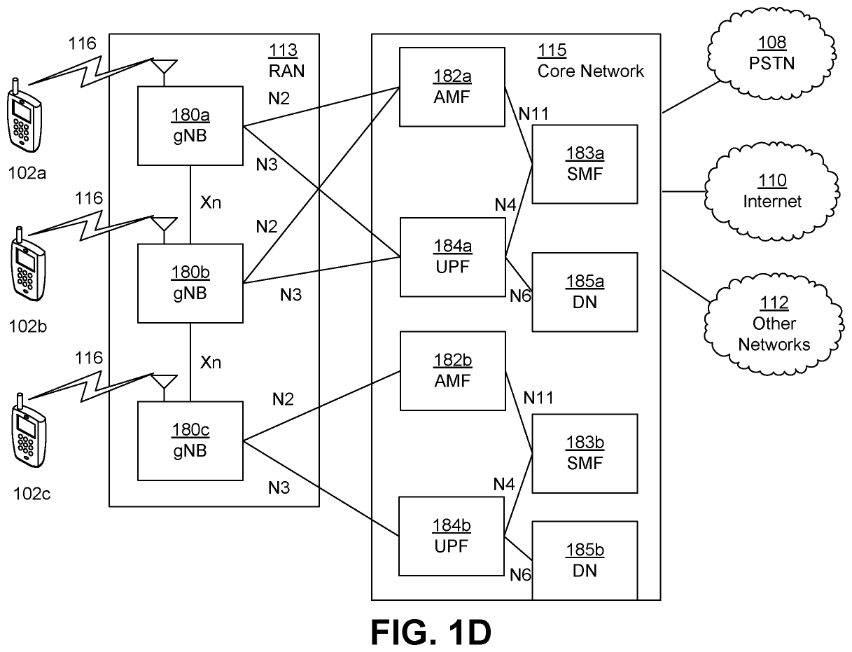

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (base station), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial intelligence (AI)/machine-learning (ML) may be used to improve an air interface such as beam management related functionalities associated with the air interface. The AI/ML technology may lay a foundation for improving the performance and/or reducing the complexity of multiple aspects of beam management, including beam prediction (e.g., in time and/or spatial domains for overhead and latency reduction), beam selection (e.g., to improve the accuracy of beam selection), and so forth.

Hybrid automatic repeat request (HARQ) feedback may include the transmission of an acknowledgment (ACK) or a non-acknowledgment (NACK) as a result of a WTRU verifying a correct or faulty reception of DL data, respectively. While the transmission of an NACK may trigger a retransmission of the data that was received with faulty content, the transmission of an ACK may impose overhead and/or latency to the overall communication system. This impact may be severe with a scheduler targeting a 10% block error rate (BLER) in eMBB systems or a much lower BLER (e.g., 10⁻⁵) in URLLC systems. The lower BLER may result in a higher rate of ACK (e.g., 90% in eMBB and 1-10⁻⁵ in URLLC) that may become a bottleneck for overhead and latency reduction.

AI/ML models and/or channel measurements (e.g., performed based on long-term observations) may predict channel conditions, beam and/or environment changes, link-adaptation parameters, and so forth for a WTRU on a serving cell and/or with a selected beam. For example, the AI/ML models may predict if there is going to be a change in the conditions at or surrounding the WTRU that may result in more NACKs (e.g., faulty receptions due to degraded channel conditions) or more ACKs (e.g., less faulty receptions due to stable/fixed channel conditions).

The use of AI/ML models and/or measurements performed by a WTRU may lead to different WTRU behaviors, e.g., with respect to the calculation and/or transmission of ACK/NACK information bits and/or the generation of codebooks. The WTRU may determine the conditions, measurements, and/or reporting occasions for lowering ACK/NACK transmission overhead based on AI/ML models (e.g., including the training, validation, activation, and/or deactivation of the AI/ML models) and/or measurements (e.g., such as channel state information (CSI) measurements). HARQ-ACK/NACK codebook generation and/or beam management (e.g., based on predictions made by AI/ML models or measurements performed by a WTRU) may be implemented.

When referred to herein, artificial intelligence (AI) may include behaviors learned and/or exhibited by machines (e.g., computing devices). Such behaviors may include, e.g., cognitive functions associated with sensing, reasoning, adapting and/or acting. When referred to herein, machine learning (ML) may include determining ways (e.g., algorithms) for solving a problem based on learning through experience (e.g., data). Machine learning may be considered a subset of AI. Different machine learning paradigms may be employed based on the nature of the data involved or feedback available to the learning. For example, a supervised learning approach may involve learning a function that maps an input to an output based on a labeled training dataset, wherein the training dataset may include paired data comprising an input and a corresponding output. An unsupervised learning approach may involve detecting patterns in the training data with no pre-existing labels. As an example of unsupervised learning, reinforcement learning may involve performing a sequence of actions in an environment to maximize a cumulative reward. In some examples, it may be possible to perform machine learning based on a combination of the above-mentioned approaches (e.g., based on supervised and unsupervised learning). For example, a semi-supervised learning approach may use a combination of labeled data and unlabeled data during the learning (e.g., during the training of an ML model). Such a semi-supervised learning approach may fall between unsupervised learning (e.g., without labeled training data) and supervised learning (e.g., with labeled training data).

When referred to herein, deep learning (DL) may include a class of machine learning techniques that may employ an artificial neural network (ANN) including a deep neural network (DNN). Such a DNN may receive an input that may be transformed (e.g., linearly transformed) and the DNN may pass the input through an activation function (e.g., a non-linear activation function) one or multiple times. The DNN may include multiple layers, wherein a (e.g., each) layer may include a transformation function (e.g., linear transformation function) and/or an activation function (e.g., a non-linear activation function). The DNN may be trained based on training data and/or back-propagation.

When referred to herein, AI/ML (or AIML) may include one or more of the learning or neural network training techniques described above.

A WTRU may transmit or receive a channel (e.g., a physical channel) or a reference signal according to at least one spatial domain filter. The term “beam” may be used interchangeably with the term “spatial domain filter.” The WTRU may transmit a physical channel or signal using the same spatial domain filter as the spatial domain filter used for receiving an RS (e.g., such as CSI-RS) or a synchronization signal (SS) block. The WTRU transmission may be referred to as a “target”, and the received RS or SS block may be referred to as a “reference” or “source.” As such, the WTRU may be said to transmit the target physical channel or signal according to a spatial relation with a reference or source such an RS or SS block.

The WTRU may perform a first transmission (e.g., a first physical channel or reference signal transmission) according to the same spatial domain filter as the spatial domain filter used for performing a second transmission. The first and second transmissions may be referred to as a “target” and a “reference” (or “source”) transmission, respectively. As such, the WTRU may be said to transmit the first (target) transmission according to a spatial relation with a reference to the second (reference) transmission.

A spatial relation may be configured (e.g., implicitly configured) via RRC signaling or via a MAC CE or DCI. For example, a WTRU may implicitly transmit a PUSCH and/or a DM-RS associated with the PUSCH according to the same spatial domain filter as a sounding reference signal (SRS) indicated by an SRS resource indicator (SRI) (e.g., received in DCI or configured via RRC signaling). As another example, a spatial relation may be configured via RRC signaling for an SRI or signaled by a MAC CE for a PUCCH. Such a spatial relation may be referred to as a beam indication.

The WTRU may receive a first (target) downlink channel or reference signal transmission according to the same spatial domain filter or spatial reception parameter(s) as a second (reference) downlink channel or reference signal transmission. An association may exist between a physical channel such as a PDCCH or PDSCH, and a DM-RS associated with the physical channel. In examples (e.g., when the first and second transmissions are both reference signals), such an association may exist when the WTRU is configured with a quasi-colocation (QCL) assumption type D between corresponding antenna ports. Such an association may be configured as a transmission configuration indicator (TCI) state. The WTRU may be indicated an association between a CSI-RS (or an SS block) and a DM-RS by an index to a set of TCI states configured via RRC signaling and/or signaled via a MAC CE. Such an indication may be referred to as a beam indication.

The term “TRP” (transmission and reception point) may be interchangeably used herein with the term “TP” (transmission point), “RP” (reception point), “RRH” (radio remote head), “DA” (distributed antenna), “BS” (base station), “sector,” and/or “cell” (e.g., a geographical cell area served by a BS). The term “multi-TRP” may be interchangeably used herein with the term “MTRP,” “M-TRP,” and/or “multiple TRPs.”

A WTRU may report channel state information (CSI), which may include one or more of a CSI-RS resource indicator (CRI), a SSB resource indicator (SSBRI), an indication of a panel used for reception at the WTRU (such as a panel identity or group identity), measurements such as L1-RSRP and/or L1-SINR taken from an SSB or CSI-RS (e.g., cri-RSRP, cri-SINR, ssb-Index-RSRP, ssb-Index-SINR, etc.), a rank indicator (RI), a channel quality indicator (CQI), a precoding matrix indicator (PMI), a Layer Index (LI), and/or the like.

A WTRU may receive a synchronization signal/physical broadcast channel (SS/PBCH) block. The SS/PBCH block (SSB) may include a primary synchronization signal (PSS), a secondary synchronization signal (SSS), and/or a physical broadcast channel (PBCH) signal. The WTRU may monitor, receive, and/or attempt to decode an SSB during initial access, initial synchronization, radio link monitoring (RLM), cell search, cell switching, and so forth.

A WTRU may measure and report channel state information (CSI). A WTRU may receive CSI related configuration information (e.g., for a connection mode), which may include CSI report configuration information, CSI-RS resource set information, and/or NZP CSI-RS resource information. The CSI report configuration information may include one or more of a CSI report quantity (e.g., a Channel Quality Indicator (CQI), a Rank Indicator (RI), a Precoding Matrix Indicator (PMI), a CSI-RS Resource Indicator (CRI), a Layer Indicator (LI), etc.), a CSI report type (e.g., aperiodic, semi-persistent, or periodic), a CSI report codebook configuration (e.g., Type I, Type II, Type II port selection, etc.), or a CSI report frequency. A CSI-RS resource set may include one or more CSI resource settings such as NZP-CSI-RS resources for channel measurement, NZP-CSI-RS resources for interference measurement, CSI-IM resources for interference measurement, etc. NZP CSI-RS resources may include one or more of an NZP CSI-RS resource ID, a periodicity, an offset, QCL information, a TCI-state, or a resource mapping (e.g., number of ports, density, CDM type, etc.).

A WTRU may indicate, determine, or be configured with one or more reference signals. The WTRU may monitor, receive, and measure one or more parameters based on respective reference signals. For example, one or more of the following may apply and the parameters listed herein may be non-limiting examples of the parameters that may be included in reference signal measurements. Further, one or more (e.g., not all) of the parameters listed herein may be included in reference signal measurements, while other parameters may also be included in reference signal measurements.

An SS reference signal received power (SS-RSRP) may be measured based on one or more synchronization signals (e.g., demodulation reference signal (DM-RS) transmitted in a PBCH or SSS). Such a power may be determined as a linear average of the power contributions of multiple resource elements (REs) that may carry respective synchronization signals. In measuring the RSRP, power scaling for the reference signals may be applied. If an SS-RSRP is used for L1-RSRP, the measurement may be accomplished based on CSI reference signals in addition to the synchronization signals.

A CSI-RSRP may be determined based on a linear average of the power contributions of multiple resource elements (RE) that may carry respective CSI-RSs. The CSI-RSRP determination or measurement may be configured within measurement resources for one or more configured CSI-RS occasions.

An SS signal-to-noise ratio (SS-SINR) and/or an interference ratio (SS-SINR) may be measured based on one or more synchronization signals (e.g., a DM-RS in PBCH or SSS). One or both of these ratios may be determined as a linear average of the power contributions of multiple resource elements (REs) that may carry respective synchronization signals, divided by a linear average of the noise and interference power contributions by those REs. If an SS-SINR is used for L1-SINR, the noise and interference power measurement may be accomplished based on resources configured by higher layers.

A CSI-SINR may be measured based on a linear average of the power contributions of multiple resource elements (REs) that may carry respective CSI-RSs, divided by a linear average of the noise and interference power contributions of those REs. If a CSI-SINR is used for L1-SINR, the noise and interference power measurement may be accomplished based on resources configured by higher layers. Otherwise, the noise and interference power may be measured based on resources that may carry the respective CSI-RSs.

A received signal strength indicator (RSSI) may be measured based on an average of the total power contributions in configured OFDM symbols and/or bandwidth. The power contribution may be received from different resources (e.g., co-channel serving and non-serving cells, adjacent channel interference, thermal noise, and so forth).

A cross-layer interference received signal strength indicator (CLI-RSSI) may be measured based on an average of the total power contributions in configured OFDM symbols (e.g., of a configured time) and/or frequency resources. The power contribution may be received from different resources (e.g., cross-layer interference, co-channel serving and non-serving cells, adjacent channel interference, thermal noise, and so forth).

A sounding reference signal RSRP (SRS-RSRP) may be measured based on a linear average of the power contributions of resource elements (REs) that may carry respective SRSes.

A CSI report configuration (e.g., a CSI-ReportConfig information element) may be associated with a bandwidth part (BWP) (e.g., indicated by a BWP-Id). One or more of the following parameters may be configured: CSI-RS resources and/or CSI-RS resource sets for channel and interference measurement, a CSI-RS report type (e.g., periodic, semi-persistent, and aperiodic), a CSI-RS transmission periodicity for periodic and semi-persistent CSI reports, a CSI-RS transmission slot offset for periodic, semi-persistent and aperiodic CSI reports, a CSI-RS transmission slot offset list for semi-persistent and aperiodic CSI reports, time restrictions for channel and interference measurements, report frequency band configuration information (e.g., wideband/subband CQI, PMI, and so forth), thresholds and modes of calculations for one or more reporting quantities (e.g., CQI, RSRP, SINR, LI, RI, etc.), codebook configuration information, group based beam reporting configuration information, a CQI table, a subband size, a non-PMI port indication, a port index; etc.

A CSI-RS resource set (e.g., configured via an NZP-CSI-RS-ResourceSet information element) may include one or more CSI-RS resources (e.g., configured via NZP-CSI-RS-Resource and/or CSI-ResourceConfig). A WTRU may be configured with one or more of the following regarding CSI-RS resources: a CSI-RS periodicity and slot offset for periodic and semi-persistent CSI-RS resources, a CSI-RS resource mapping that may define the number of CSI-RS ports, density, CDM-types, OFDM symbols, and/or subcarrier occupancy, the bandwidth part to which a configured CSI-RS is allocated, a reference to a TCI-State including QCL source RS(s) and/or the corresponding QCL type(s).

One or more of following may be associated with an RS resource set: an RS resource set ID, one or more RS resources for the RS resource set, a repetition indication (e.g., on or off), an aperiodic triggering offset (e.g., one of 0-6 slots), TRS information (e.g., true or false), etc.

One or more of following may be associated with an RS resource: an RS resource ID, a resource mapping (e.g., REs in a PRB), a power control offset (e.g., a value of −8, . . . , 15), a power control offset with SS (e.g., −3 dB, 0 dB, 3 dB, 6 dB, etc.), a scrambling ID, a periodicity and offset, QCL information (e.g., based on a TCI state), etc.

A grant or assignment (e.g., transmitted via DCI) may indicate one or more of the following: a frequency allocation, an aspect of time allocation (e.g., such as a duration), a priority, a modulation and coding scheme, a transport block size, a number of spatial layers, a number of transport blocks, a TCI state, a CRI, an SRI, a number of repetitions, whether a repetition scheme is Type A or Type B, whether the grant is a configured grant type 1, type 2 or a dynamic grant, whether the assignment is a dynamic assignment or a semi-persistent scheduling (configured) assignment, a configured grant index or a semi-persistent assignment index, a periodicity of a configured grant or assignment, a channel access priority class (CAPC), other parameter(s) provided via DCI, by a MAC CE or by RRC signaling for the scheduling grant or assignment, etc.

A DCI indication may indicate one or more of the following: an explicit indication provided via a DCI field or via an RNTI used to mask the CRC of a PDCCH transmission, or an implicit indication that may be implied by a property such as a DCI format, a DCI size, a coreset or search space, an aggregation level, a first resource element of the received DCI (e.g., an index of a first control channel element), where a mapping between the property and its value may be provided via RRC signaling or a MAC CE.

When referred to herein, an RS may include one or more of an RS resource, an RS resource set, an RS port, an RS port group, an SSB, a CSI-RS, an SRS, a DM-RS, a TRS, a position reference signal (PRS), or a phase tracking reference signal (PTRS). When referred to herein, a reference signal may include a sounding reference signal (SRS), a channel state information-reference signal (CSI-RS), a demodulation reference signal (DM-RS), a phase tracking reference signal (PTRS), or a synchronization signal block (SSB). When referred to herein, a channel may include a PDCCH, a PDSCH, a Physical uplink control channel (PUCCH), a physical uplink shared channel (PUSCH), a physical random access channel (PRACH), etc. The terms signal, channel, and message (e.g., as in DL or UL signal, channel, or message) may be used interchangeably herein. The term RS resource set may be interchangeably used herein with the term RS resource or beam group. The term beam reporting may be interchangeably used herein with the term CSI measurement, CSI reporting, or beam measurement. When described herein, a beam resource prediction technique may be applied to beam resources that may belong to a single cell or multiple cells, a single or multiple TRPs, etc. The term CSI reporting may be used interchangeably herein with the term CSI measurement, beam reporting, or beam measurement. The term RS resource set may be used interchangeably herein with the term beam group. When used herein, the term HAORAP (HARQ-ACK overhead reduction procedure) may refer to techniques, solutions and/or procedures associated with reducing the overhead associated with HARQ-ACK transmissions in some examples. The techniques described in the examples related to activating, deactivating, and/or applying a HAORP may also be used in other procedures, actions, services, functions, events, etc. The term “HARQ-ACK overhead reduction procedure” or “HAORP” may include procedures, actions, services, functions, events, and/or the like.

A WTRU may be configured with one or more resource allocations for uplink transmissions (e.g., data channels) in one or more transmission occasions. For example, for a control channel transmission (e.g., PUCCH), a resource allocation or configuration may include one or more settings or parameters, such as a starting PRB, a second hop starting PRB, a number of PRBs, a number of slots, a starting symbol index, a PUCCH format, a cyclic shift, an orthogonal cover code (OCC) configuration, and/or the like that may be indicated based on a PUCCH resource index or indicator (e.g., such as a PUCCH-ResourceId).

In examples, for a downlink (shared) channel transmission (e.g., PDSCH) configured by semi-static indications (e.g., SPS PDSCH configured by SPS-Config), the WTRU may determine or be configured with an associated PUCCH resource index or indicator that the WTRU may use to send corresponding control information (e.g., HARQ-ACK, CSI report, etc.). For instance, the time resources (e.g., slots) for the transmission of a HARQ-ACK in a respective PUCCH may be defined based on one or more RRC-configured parameters (e.g., a K1 defined via dl-DataToUL-ACKof PUCCH-Config in BWP-UplinkDedicated), or activated via DCI (e.g., format 1_1 or 1_2 with a PDSCH-to-HARQ_feedback timing indicator field).

In examples, for an uplink shared channel transmission (e.g., PUSCH), a resource allocation or configuration may be indicated based on one or more settings or parameters, such as time resources (e.g., timeDomainAllocation), frequency resources (e.g., frequencyDomainAllocation), a periodicity, a repetition, etc. For example, for a PUSCH transmission corresponding to a first configured grant (e.g., Type 1) or for a PUSCH transmission corresponding to a second configured grant (e.g., Type 2) and activated by DCI, a resource allocation may be provided by one or more parameters (e.g., via ConfiguredGrantConfig in BWP-UplinkDedicated and/or an activating UL grant received via DCI).

For a PUSCH transmission corresponding to an UL grant (e.g., a dynamic grant), a time domain resource assignment (TDRA) (e.g., received in DCI) may indicate a slot offset (e.g., K2 via a indexed row), a start and length indicator (e.g., SLIV), a start symbol and/or allocation length, a PUSCH mapping type, the number of slots for a transport block size (TBS) determination, and/or the number of repetitions for the PUSCH transmission.

A WTRU may be configured with one or more PUCCH resource sets, including one or more PUCCH resources. In examples, PUCCH resource configure parameters may include a PUCCH resource index, an index for a first PRB, an index for a first PRB for frequency hopping, a PUCCH format, a starting symbol index, a number of symbols, a number of PRBs, and/or the like.

A WTRU may be configured with a PUCCH resource indicator (PRI) field (e.g., via DCI). In examples, the PRI may be indicated by one or more bits (e.g., up to three bits), where the PRI may map to a set of PUCCH resource indices corresponding to multiple (e.g., up to eight) PUCCH resources provided by a PUCCH resource set. The WTRU may use the PRI to determine the resource allocation to be used for a PUCCH transmission.

A WTRU may receive configuration information regarding the time and/or frequency resources for transmitting HARQ ACK/NACK feedback. The HARQ ACK/NACK timing for the reception of a downlink signal and/or channel may be configured, for example, by one or more higher layer parameters (e.g., K1). In examples, a K1 parameter may indicate an index in a table specified by an RRC parameter (e.g., dl-DataToUL-ACK in PUCCH-Config), as shown below in the non-limiting examples of parameters that may be included in PUCCH configuration information. One or more of the shown parameters may be included. The number of bits and/or choices for each parameter are merely examples and other numbers of bits and/or choices may be included.

| | |
|---|---|
| PUCCH-Config ::= | SEQUENCE { |

. . .

resourceToAddModList SEQWTRUNCE (SIZE (1 . . .

maxNrofPUCCH-Resources)) OF PUCCH-Resource

| | |
|---|---|
| dl-DataToUL-ACK | SEQUENCE (SIZE (1 . . . 8)) OF |

INTEGER (0 . . . 15) Optional
. . .
}
maxNrofPUCCH-Resources INTEGER ::= 128

A WTRU may receive one or more reference signals and/or channel transmissions (e.g. in the downlink). The WTRU may receive configuration information associated with generating one or more HARQ-ACK information bits and/or HARQ-ACK codebooks. In an example, the WTRU may report HARQ-ACK information for one or more PDSCH receptions, one or more PDCCH (e.g., DCI) receptions, one or more TCI state updates, a PDSCH transmission without a corresponding PDCCH, a PDCCH transmission indicating a SPS PDSCH release, and/or the like. The WTRU may report the HARQ-ACK information bits in a HARQ-ACK codebook (e.g., Type-1, Type-2, Type-3, etc.) that the WTRU may transmit in a slot indicated by a timing indicator (e.g., a PDSCH-to-HARQ feedback timing indicator field in a corresponding DCI format). In an example, the WTRU may determine if the resources for a HARQ-ACK report are mapped to a PUCCH or PUSCH.

The WTRU may determine

$${\tilde{O}}_{0}^{A C K} , {\tilde{O}}_{1}^{ACK} , … , {\tilde{O}}_{{O}_{ACK} - 1}^{A C K}$$

HARQ-ACK information bits for a total number of O_{ACK} HARQ-ACK information bits. The WTRU may be configured with one or more HARQ-ACK codebook indices for multiplexing the corresponding HARQ-ACK information bits (e.g., per SPS PDSCH configuration).

The WTRU may determine the total number of transport blocks (TBs) or code block groups (CBGs) to be received based on one or more configurations and/or one or more DCI (e.g., comprising a grant) indications received by the WTRU. In an example, the WTRU may be indicated or configured to receive one or more PDSCH downlink transmissions. The WTRU may use a total downlink assignment index (DAI) field in a UL grant DCI to determine the total number of TBs or CBGs to be received.

Overhead associated with downlink HARQ-ACK transmissions may be reduced based on AI/ML models and/or channel or beam measurements. A WTRU may enable, use, or activate a HARQ-ACK overhead reduction procedure (HAORP) for a received DL transmission and/or for a determined time duration (T_{HAORP}) based on one or more of the following. The WTRU may measure CSI based on configuration information associated with CSI-RS resources for channel and interference measurement and/or CSI reporting in an active BWP. The WTRU may use an AI/ML model based on long-term observations and may determine whether to enable the HAORP based on the AI/ML model's output (e.g., prediction). The inputs to the AI/ML model may include a mobility status, measured channel and/or interference parameters for one or more beam resources, etc. The condition for activating or deactivating the HAORP may be determined respectively based on whether a channel condition may lead to consecutive ACKs or NACKs. The WTRU may receive an explicit indication (e.g., a higher layer parameter such as an RRC configuration parameter, a SIB, etc.) from a base station to activate/deactivate the HAORP. For example, if the WTRU determines, based on one or more measurements and respective thresholds associated with the measurements, that one or more conditions (e.g., consecutive ACKs, low mobility, low environmental traffic, etc.) for activating the HAORP may be satisfied, the WTRU may trigger a transmission (e.g., a report transmission) to the base station and may include measured parameters (e.g., regarding mobility, channel conditions, BLER, traffic model, crowdedness, etc.) in the transmission (e.g., report). The base station may use the reported parameters to determine if the HAORP may be used, activated, and/or enabled for the WTRU, and may send a message (e.g., an indication) regarding activation or deactivation of the HAORP to the WTRU.

A WTRU may switch between performing TB-based HARQ feedback and performing CBG-based HARQ feedback. With an HAORP, the WTRU may send TB-based feedback (e.g., instead of CBG-based feedback, spatial multiplexing feedback, etc.). If the WTRU is configured to provide CBG-based HARQ feedback, the WTRU may determine or receive an indication (e.g., via DCI or a MAC-CE) to switch to TB-based HARQ feedback. The WTRU may receive resources (e.g., PUCCH resources) that may be used for TB-based HARQ feedback. The switching may be cell-based (e.g., multiple WTRUs may receive the indication to switch) or WTRU-based (e.g., a specific WTRU may receive the indication to switch). The switching may be performed in multiple cells or multiple carriers operating in carrier aggregation, or in one of the cells or carriers. The switching may be performed for new data transmissions or for both new data transmissions and retransmissions.

A WTRU may receive configuration information associated with CSI-RS resources such as CSI-RS resources for channel and interference measurement and/or CSI reporting in an active BWP. The activation or deactivation of a HAORP may be determined based on measurements of a CSI-RS (e.g., a low BLER may result in the activation of the HAORP) and/or factors such as the number of consecutive HARQ-ACK/NACKs transmitted (e.g., consecutive ACKs and infrequent NACKs may lead to the activation of the HAORP) or indications included in HARQ-ACK feedback (e.g., the feedback may include one or more flag indications for activating/deactivating the HAORP). The WTRU may measure a CSI-RS resource and may determine, based on the measurement, if a channel condition may result in consecutive ACK generations. If the determination is that consecutive ACK generations are likely, the HAORP may be enabled (e.g., based on an AI/ML model). If the WTRU determines to enable the HAORP, the WTRU may indicate the enablement to a base station, for example, as part of a (periodic, semi-persistent, or aperiodic) CSI report. The WTRU may send an indication (e.g., a flag indication) to the base station to request enablement of the HAORP. The indication may include a carrier indicator for which the HAORP may be performed. The WTRU may send the indication (e.g., CSI report) as part of an operation to report/request the activation/indication of the HAORP, which may or may not be based on a CSI-RS. For example, the activation/indication of the HAORP may be based on HARQ-ACK feedback (e.g., enhanced with one or more flag indications).

A handshake may be performed between a WTRU and a base station for a dynamic HAORP. If the WTRU determines to perform the HAORP, the WTRU may request or suggest to the base station to use one or more pre-configured settings and/or parameters for corresponding DL transmissions. Such a request may include, for example, a request not to change a determined MCS for the same CQI and/or SINR, a determined time duration to apply the HAORP (T_{HAORP}), an indication for the base station to use TB-based HARQ-ACK feedback despite having a CBG-based configuration and/or a spatial multiplexing based configuration for a relevant cell or carrier, etc. The WTRU may receive an indication from the base station (e.g., via DCI) that may confirm or reject the request. The indication may include a flag (or a bit field) to enable or disable one or more of the aforementioned parameters. The indication may include a value (e.g., an updated value) for the time interval or carrier(s) over which the HAORP may be applied. The indication may include a priority for activating or deactivating the HAORP. The indication may be associated with one or more PDSCH receptions. For example, the WTRU may receive the indication via a grant DCI to activate or deactivate the HAORP specifically for that PDSCH grant (e.g., the HAORP may be activated for a single or specific PDSCH grant). The indication may be received implicitly. For example, if the base station schedules the WTRU with a higher MCS, the WTRU may know that the base station does not approve the HOARP and, in response, the WTRU may perform the HARQ feedback as usual (e.g., in a legacy manner or format). If the base station receives the request to activate the HAORP as part of a CSI report, the base station may expect that the WTRU is (e.g., is capable of) performing predictions about the HAORP activation/deactivation conditions.

If the WTRU determines to disable a HAORP (e.g., based on an increased rate of HARQ-NACK or a determination that there are fewer or no more consecutive ACK transmissions), the WTRU may indicate deactivation (e.g., via a flag or bit field in a CSI report) of the HAORP for a corresponding carrier to the base station.

A WTRU may determine to enable/disable, use/not use, or activate/deactivate a HAORP for DL receptions for a determined time duration (T_{HAORP}), for a determined number of DL signal samples (N_{HAORP}), or until triggered by a change in measurement (e.g., a sudden change in a channel condition). The enablement/disablement, use/non-use, or activation/deactivation of the HAORP may be based on one or more of the following.

The enablement/disablement, use/non-use, or activation/deactivation of a HAORP may be based on WTRU CSI measurements or other types of measurements (e.g., other types of channel measurements). The WTRU may be configured to activate or deactivate the HAORP procedure or determine the length and/or size of T_{HAORP} and/or N_{HAORP} based on CSI parameters that the WTRU may compute or otherwise determine. For example, a measurement of a CQI above a threshold may trigger the WTRU to activate the HAORP procedure. The WTRU may activate/deactivate the HAORP procedure or determine the length and/or size of T_{HAORP} and/or N_{HAORP} based on additional channel measurements, such as, e.g., an SNR, a Doppler spread, a channel coherence time, a channel coherence bandwidth, etc. In examples, the WTRU may activate the HAORP procedure for an SNR range above a preconfigured threshold. In examples, changes in measured channel conditions may trigger the WTRU to assess the suitability of using the HAORP. For example, a decrease in the channel coherence time may indicate that the channel is changing from a slow-fading channel to a fast-fading channel and therefore may no longer be suitable for the HAORP procedure. This may trigger the WTRU to switch to a legacy HARQ reporting mechanism (e.g., immediately). In examples, a decrease in the channel coherence time may result in the WTRU decreasing the length and/or size of T_{HAORP} and/or N_{HAORP}. In examples, one channel parameter may not be sufficient for determining whether the criteria for activating the HAORP is met, and this may cause the WTRU to measure additional channel parameter(s) (e.g., a second and/or third channel parameters). For example, a large channel coherence time measurement may be indicative of a slow-fading channel being appropriate for the HAORP procedure. Based on such a measurement, the WTRU may be configured to make additional measurements (e.g., SINR) to confirm a channel quality before activating the HAORP.

The enablement/disablement, use/non-use, or activation/deactivation of a HAORP may be based on a request or configuration from a base station, which in turn may be based on WTRU CSI reporting. For example, a WTRU may be configured to report CSI on a PUCCH or PUSCH grant. A CSI-RS associated with the CSI reporting may be configured for the full bandwidth of a bandwidth part or a fraction of the bandwidth part. Within the CSI-RS bandwidth, a CSI-RS may be configured in each PRB or every other PRB. The WTRU may compute or otherwise determine CSI parameters based on one or more of these configurations and may transmit (e.g., report) the CSI parameters to the base station. The CSI parameters may assist a scheduler at the base station in allocating resources and determining MCSs, precoding matrices, beams, and/or transmissions modes. The CSI parameters may also assist the base station in determining whether to enable HAORP for the WTRU and the duration for using the HAORP. The WTRU may subsequently receive from the base station an indication to enable/disable, use/not use, and/or activate/deactivate the HAORP.

The WTRU may be configured with CSI-RS resources periodically, semi-periodically, or aperiodically in the time domain. Upon determining and reporting CSI parameters to the base station, the WTRU may receive an indication from the base station to enable/disable, use/not use, and/or activate/deactivate HAORP. A semi-persistent CSI-RS configuration at the WTRU may be similar to a periodic CSI-RS, except that the resources may be activated and/or deactivated via a MAC CE and the WTRU may report measurements on (e.g., only on) the activated resources. For an aperiodic CSI-RS, the WTRU may be triggered to report measured CSI on the PUSCH, e.g., based on a request received in DCI. In examples, a MAC CE may be used to activate or deactivate resources for semi-persistent CSI-RS reporting. The MAC CE may carry an indication from the base station to enable/disable, use/not use, and/or activate/deactivate the HAORP. In examples, DCI such as that used for the activation or deactivation of resources for aperiodic CSI-RS reporting may carry an indication from the base station to enable/disable, use/not use, and/or activate/deactivate the HAORP.

The WTRU may be configured to report explicit CSI parameters (e.g., a full CSI matrix) and/or implicit CSI (e.g., channel parameters such as CQI, PMI, RI, LI, etc.) to the base station. In examples, upon reporting of CSI parameters to the base station (e.g., a CQI greater than a threshold, an RSRP greater than a threshold, etc.), the base station may allocate CSI-RS resources to the WTRU for reporting one or more other CSI parameters (e.g., a full CSI matrix), e.g., such that the base station may confirm that the channel conditions are suitable before sending an indication to the WTRU to activate the HAORP. In examples, the base station may send a command to the WTRU to activate the HAORP once the WTRU has reported certain CSI parameters to the base station (e.g., a CQI greater than a threshold, an RSRP greater than threshold, etc.). Reporting of the other CSI parameters (e.g., a full CSI matrix) may assist the base station in determining the size and/or length of T_{HAORP} and/or N_{HAORP}.

The WTRU may be configured to determine and report CSI parameters one or multiple times. In examples, upon reporting CSI parameters to the base station and receiving an indication to activate the HAORP, the WTRU may not receive additional CSI-RS resources for the duration of T_{HAORP} and/or N_{HAORP}. In examples, the WTRU may be configured to keep determining and reporting CSI parameters to the base station throughout the duration of T_{HAORP} and/or N_{HAORP}, for example, to allow the base station to dynamically adjust the length and/or size of T_{HAORP} and/or N_{HAORP} based on the updated CSI parameters. An indication from the base station to enable/disable, use/not use, and/or activate/deactivate the HAORP may be applicable to transmissions (e.g., DL transmissions) that occur in a determined time duration (e.g., T_{HAORP}), for a determined number of DL transmissions (e.g., N_{HAORP}), or until further notice.

The enablement/disablement, use/non-use, or activation/deactivation of a HAORP may be based on a request, command, or configuration from the base station, which in turn may be based on parameters such as channel and/or interference parameters reported by the WTRU. The base station may enable/disable, use/not use, and/or activate/deactivate the HAORP based on measurements and reports from the WTRU including, for example, an SNR, a Doppler spread, a channel coherence time, a channel coherence bandwidth, etc.

In examples, the WTRU may be configured to measure and report changes in channel parameters. Based on these measurements and reports, the base station may send to the WTRU an indication (e.g., a command) to activate the HAORP. For example, upon measurement of a change in the channel coherence time, the WTRU may send an indication to the base station to report the change. The WTRU may report additional measurements (e.g., CQI, SNR, etc.) to the base station in a separate report or by including them as part of the same CSI feedback report. The WTRU may determine that a condition for activation or deactivation of the HAORP is satisfied (e.g., consecutive ACK, low mobility, low environmental traffic, etc.) based on one or more measurements and respective thresholds associated with the measurements. The WTRU may trigger a report transmission to the base station to send the measured parameters (e.g., mobility, channel conditions, BLER, traffic model, crowd, etc.) to the base station. The base station may use the reported parameters to determine if the HAORP should be used, activated, and/or enabled for the WTRU.

The enablement/disablement, use/non-use, or activation/deactivation of a HAORP may be based on one or more AI/ML models at the WTRU. The WTRU may be configured with one or more AI/ML models for determining whether to enable/disable, use/not use, and/or activate/deactivate the HAORP and/or for determining the applicable length and/or size of T_{HAORP} and/or N_{HAORP}. The WTRU may request and/or download from the base station one or more AI/ML models for the HAORP if, for example, the WTRU does not have a trained and/or updated AI/ML model suitable for that purpose. The WTRU may be configured with one or more AI/ML models that may not be related to the HAORP but may still assist the WTRU in determining whether to enable/disable, use/not use, and/or activate/deactivate the HAORP and/or the size of T_{HAORP} and/or N_{HAORP}. For example, the one or more AI/ML models may predict CSI parameters for an upcoming time window. Based on the predicted CSI parameters, the WTRU may determine whether to activate or deactivate the HAORP. Based on the length of the prediction window from the AI/ML model(s), the WTRU may determine the size of T_{HAORP}, N_{HAORP}, etc. The WTRU may request and/or download such AI/ML model(s) from the base station. The WTRU may use the AI/ML model(s) based on long-term observations and may determine whether to activate/deactivate the HAORP based on the AI/ML model(s). The inputs to the AI/ML model(s) may include one or more of parameters such as a WTRU mobility status, RSRP measurements, measured channel and/or interference parameters for one or more beam resources, etc. For example, the inputs to the AI/ML model(s) may include a mobility status of the WTRU and the WTRU may determine that a low mobility status should trigger the enablement, use, and/or activation of the HAORP. The AI/ML model(s) may determine and/or indicate the mobility threshold(s) that may constitute the “low” mobility status for triggering the HAORP (e.g., based on historical data). The AI/ML model(s) may determine and/or indicate the length and/or size of T_{HAORP} and/or N_{HAORP}. As another example, the inputs to the AI/ML model(s) may include an RSRP measurement since an RSRP measurement greater than a threshold may indicate a favorable condition for activating the HAORP.

The enablement/disablement, use/non-use, or activation/deactivation of a HAORP may be based on one or more AI/ML models at the base station. The output of such AI/ML model(s) may indicate whether to activate or deactivate the HAORP and/or the length and/or size of T_{HAORP} and/or N_{HAORP}. The WTRU may receive from the base station a request for measurements (e.g., CSI parameters, SINR, Doppler spread, RSRP, etc.) that may be used as inputs to the AI/ML model(s) at the base station. The WTRU may receive from the base station a command to enable/disable, use/not use, and/or activate/deactivate the HAORP and/or an indication of the length and/or size of the T_{HAORP} and/or N_{HAORP}.

The enablement/disablement, use/non-use, or activation/deactivation of a HAORP may be based on ACK/NACK statistics monitored at the WTRU. The WTRU may decide to measure and/or monitor ACK/NACK statistics over a time window. For example, if the number and/or percentage of ACK responses recorded over the time window exceeds a pre-configured threshold, the WTRU may activate the HAORP or increase the length and/or size of T_{HAORP} and/or N_{HAORP}.

The enablement/disablement, use/non-use, or activation/deactivation of a HAORP may be based on ACK/NACK statistics measured by the WTRU and/or monitored by the base station. For example, if the WTRU sends several consecutive NACKs to the base station, the base station may not send a HAORP activation command to the WTRU. In that situation, if the HAORP was previously activated, the base station may send a deactivation indication or an indication to reduce the size of T_{HAORP} and/or N_{HAORP} to the WTRU. As another example, if the WTRU has an AI/ML model for predicting whether to activate or deactivate the HAORP and if the WTRU sends several consecutive NACKs to the base station, the base station may send a request to the WTRU to assess the performance of the AI/ML model. The base station may send a request for training and/or retraining of the HAORP AI/ML model at the WTRU.

The enablement/disablement, use/non-use, or activation/deactivation of a HAORP may be based on an indication from a higher layer such as an application layer. For example, the WTRU may receive an indication from an application layer associated with an AI/ML application running on the WTRU to activate or deactivate the HAORP.

In one or more of the examples described herein, the WTRU may repeatedly activate the HAORP (e.g., instead of increasing the length and/or size of T_{HAORP} and/or N_{HAORP}). For example, the WTRU may be configured to activate the HAORP for a time duration and/or for a number of HARQ-ACKs (e.g., which may be controlled by T_{HAORP} and/or N_{HAORP}). When the time duration or number of HARQ-ACKs is reached (e.g., as indicated by a timer or a counter), the WTRU may decide to continue with the HAORP, in which case the WTRU may activate the HAORP again (e.g., for another iteration of the timer or counter). This way, the WTRU may repeatedly activate the HAORP, for example, until a change in measurements (e.g., a sudden drop in CQI) is detected and/or measured by the WTRU.

The WTRU may be indicated (e.g., explicitly) the length or size of T_{HAORP} and/or N_{HAORP} when the WTRU receives a HAORP activation indication (e.g., command) from the base station. The WTRU may be pre-configured with values of T_{HAORP} and/or N_{HAORP} from which the WTRU may determine a suitable value when activating the HAORP.

A WTRU may switch between TB-based HARQ feedback and CBG-based feedback. For example, the WTRU may be configured to perform HARQ feedback using TB-based HARQ or CBG-based HARQ. The WTRU may then receive a PDSCH that may carry a TB comprising one or more CBGs. A (e.g., each) CBG may include one or more code blocks (CBs). The WTRU may determine if it has received the TB or CBG(s) successfully or unsuccessfully. For instance, the WTRU may determine that the TB has been successfully received if a CRC check for the TB succeeds, and the WTRU may determine that the TB reception has been unsuccessful if the CRC check for the TB fails. As another example, the WTRU may determine that the reception of a CBG is successful if all of the CBs in the CBG have been received successfully (e.g., the reception of a CB may be deemed successful if the CRC check of the CB succeeds). The WTRU may determine that the reception of a CBG is unsuccessful if at least one of the CBs of the CBG was not received successfully (e.g., the reception of a CB may be deemed unsuccessful if the CRC check for the CB fails). If the WTRU receives a TB or CBG successfully, the WTRU may indicate a positive acknowledgement (ACK) for the TB or CBG. If the WTRU does not successfully receive a TB or CBG, the WTRU may indicate a negative ACK (NACK) for the TB or CBG. The WTRU may transmit HARQ feedback for one or more TBs and/or one or more CBGs (e.g., together) in a resource (e.g., in one or more time and/or frequency resources) or transmission, such as in a PUSCH or PUCCH resource or transmission. The terms feedback, HARQ feedback, HARQ, HARQ-ACK feedback and HARQ-ACK may be used interchangeably herein. A HARQ feedback may correspond to one or more transmissions, such as one or more DL or PDSCH transmissions. A HARQ feedback may include or indicate one or more ACKs and/or one or more NACKs for the one or more transmissions.

In examples, a WTRU may receive from a base station a DCI (e.g., a DL grant DCI) that may schedule a PDSCH transmission. The base station may then transmit a TB over the PDSCH, and the WTRU may attempt to receive or decode the TB, which may be successful or unsuccessful. If the TB comprises N CBGs, the WTRU may attempt to receive or decode one or more of the N CBGs and may receive or decode each of those CBGs successfully or unsuccessfully.

For TB-based HARQ, the WTRU may transmit an ACK or a NACK for the TB based on whether or not the TB was received successfully. For CBG-based HARQ with N CBGs, the WTRU may transmit an ACK or NACK for each of the N CBGs based on whether or not the CBG was received successfully, e.g., based on whether all of the CBs of the CBG were received successfully.

PDSCH or DL transmissions may be used as examples in the present disclosure. It should be noted, however, that other types of transmissions may also be performed using the techniques described herein. For example, a transmission for which a WTRU sends HARQ feedback may be a sidelink transmission of a TB over a physical sidelink shared channel (PSSCH) that may be scheduled via DCI or sidelink control information (SCI). In the examples provided herein, the downlink may be replaced by a sidelink and the DCI may be replaced by SCI, without affecting the validity of this disclosure.

The switch between TB-based HARQ feedback and CBG-based HARQ feedback may be performed dynamically. A WTRU may use a first HARQ type (e.g., transmit HARQ feedback for a PDSCH or a TB using the first HARQ type), where the first HARQ type may be TB-based HARQ or CBG-based HARQ as configured for the WTRU. The WTRU may, after starting to use the first HARQ type, receive an indication to switch to or use a second HARQ type (e.g., the second HARQ type may be CBG-based HARQ if the WTRU was previously using TB-based HARQ, or TB-based HARQ if the WTRU was previously using CBG-based HARQ). The indication may direct the WTRU to use the second HARQ type for a specific transmission (e.g., based on a DCI scheduling the transmission), for a time period (e.g., based on a timer), for a number of transmissions (e.g., based on a DCI or MAC CE), or until an indication to switch back (or again) is received (e.g., based on an activation/deactivation that may be received in a DCI or MAC CE).

The WTRU may receive the indication to use or switch to the second HARQ type after sending a request to a network device (e.g., a base station) to use or switch to the second HARQ type. The indication to use or switch to the second HARQ type and the actual use of the second HARQ type (e.g., based on the indication) may be for one or more cells (e.g., which may be specified in the indication), for one or more HARQ processes (e.g., which may be specified in the indication), one or more transmission priorities (e.g., applicable to a first priority and not a second priority, or applicable to an indicated or configured priority), etc.

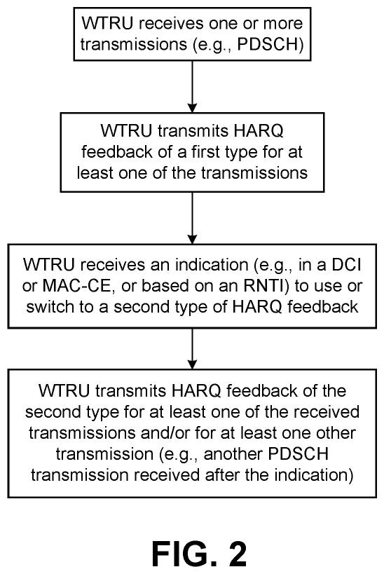

FIG. 2 illustrates an example of dynamic HARQ feedback type switching. As shown in the example of FIG. 2, a WTRU may carry out one or more of the following actions. The WTRU may receive one or more transmissions (e.g., PDSCH transmissions) and may transmit HARQ feedback of a first type (e.g., TB-based HARQ feedback) for at least one of the transmissions. The WTRU may receive (e.g., based on sending the HARQ feedback of a first type, after sending the HARQ feedback of a first type, etc.) an indication to use or switch to a second type of HARQ feedback (e.g., the indication may be received in a DCI transmission or a MAC-CE, or based on an RNTI such as an RNTI associated with a DCI transmission). The WTRU may transmit HARQ feedback of the second type (e.g., CBG-based HARQ feedback) for at least one of the transmissions already received and/or for another transmission (e.g., another PDSCH transmission) received after the indication. The WTRU may continue to use the second HARQ type until a pre-configure event or trigger occurs. For example, the WTRU may continue to use the second HARQ type until a time period expires or until another indication to change the HARQ type is received.

TB-based HARQ and CBG-based HARQ are used herein as examples of HARQ types that a WTRU may use. Other types of HARQ feedback such as any other HARQ types described here (e.g., HARQ-ACK spatial multiplexing) may also be used as the first or second HARQ type described herein, and still be consistent with this disclosure.

In examples, a WTRU may receive DCI scheduling a PDSCH transmission. The DCI may indicate the type of HARQ feedback (e.g., TB-based, CBG-based, or a mixture of TB- and CBG-based HARQ feedback) to use for the PDSCH transmission and the WTRU may transmit HARQ feedback for the PDSCH using the indicated type. In examples, the WTRU may be using a first HARQ type and the DCI may indicate that the WTRU is to switch to a second HARQ type. After receiving the indication, the WTRU may switch to using the second HARQ type. The first HARQ type may be a default or a configured HARQ type.

In examples, a first HARQ type (e.g., TB-based HARQ) may be used by a WTRU as the default HARQ type and the WTRU may later receive configuration information indicating that the WTRU is to switch to a second HARQ type. In these examples, the second HARQ type (e.g., CBG-based HARQ) may be considered a configured HARQ type.

A WTRU may apply DCI-based HARQ type use or switching to one or more received (e.g., PDSCH) transmissions. When the WTRU receives an indication in the DCI to use or switch to a HARQ type, the WTRU may use or switch to the indicated HARQ type for transmitting HARQ feedback for one or more transmissions scheduled by the DCI, for one or more (e.g., all) of the transmissions for which the WTRU may send HARQ feedback in the same resource (e.g., the same PUCCH or PUSCH resource), for one or more transmissions of a certain priority, etc.

The DCI that indicates a HARQ type use or switching may be a scheduling DCI such as a DL grant DCI. The DCI may be associated with a WTRU-specific RNTI such as a C-RNTI (e.g., the CRC of the DCI may be masked or scrambled by the C-RNTI).

The DCI that indicates a HARQ type use or switching may be a non-scheduling DCI, which may be associated with a WTRU-specific RNTI, a group-specific RNTI, or a cell-specific RNTI. The RNTI used with the DCI may be configured (e.g., the WTRU may receive configuration information indicating the RNTI associated with the DCI).

Upon receiving a DCI (e.g., a non-scheduling DCI or a scheduling DCI) indicative of the use or switching to a HARQ type, a WTRU may use the indicated HARQ type for one or more transmissions. For example, the WTRU may use the indicated HARQ type for at least one transmission (e.g., a transmission scheduled by the DCI), for a first transmission after the reception of the DCI, for one or more (e.g., all) scheduled transmissions after the reception of the DCI until being indicated to use or switch to another HARQ type, or until a time period expires, etc.

A transmission described herein may be a scheduled transmission. The transmission may be dynamically scheduled (e.g., by a DCI) or a semi-persistently scheduled (SPS) transmission that may be based on a received configuration. The WTRU may determine which transmission is the first transmission after a DCI reception based on an indication in the DCI (e.g., a time offset), an application time or time offset that may be configured, and/or a condition (e.g., a new data condition). For example, the WTRU may receive a DCI (e.g., a PDCCH transmission carrying the DCI) that may indicate to use or switch to a HARQ type. The DCI may include an indication of a time offset for using the HARQ type or the WTRU may be configured with such a time offset. The time offset may be relative to the time (e.g., a slot, a first symbol, a last symbol, etc.) of the PDCCH transmission, and the WTRU may use the indicated HARQ type for transmissions received or scheduled after the time offset. For example, if the WTRU receives the PDCCH transmission carrying the DCI in slot n and the time offset is 3 slots, the WTRU may use (e.g., begin to use) the indicated HARQ type for a PDSCH received in or after slot n+3. As another example, the WTRU may use the indicated HARQ type for a PDSCH scheduled by a PDCCH, wherein the PDCCH may be received in or after slot n+3.

A time period associated with the use of a HARQ type may begin when a DCI (e.g., a PDCCH transmission carrying the DCI) is transmitted or received, or based on a time offset after the DCI is transmitted or received. The time period may begin based on an indicated or configured time offset. For instance, in the example where the PDCCH carrying the DCI is received in slot n and the time offset is set to 3 slots, the time period may begin in (e.g., at the start of) slot n+3. The time period may be defined in time units such as slots or symbols, or in actual time such as milliseconds. When the indicated HARQ type is the same HARQ type as that currently in use, the WTRU may use the indicated HARQ type without any delay.

A condition may be set for a WTRU to apply an indicated HARQ type (e.g., switches to using the indicated HARQ type) when the WTRU receives new data. The WTRU may determine that a scheduled transmission (e.g., PDSCH) is a new transmission based on a new data indicator (NDI) in the scheduling DCI. New data may be indicated for a HARQ process when the NDI is toggled (e.g., a different value from the previous value) for the HARQ process.

The HARQ process associated with a transmission (e.g., PDSCH transmission) may be indicated in a DCI (e.g., a scheduling DCI) or may be determined by the WTRU. Indicating or applying a HARQ type for a HARQ process may mean indicating or applying the HARQ type for transmissions associated with the HARQ process.

The first transmission to which a WTRU may apply an indicated HARQ type (e.g., a HARQ type different than the type currently used) may be the first transmission (e.g., first PDSCH) indicated as new data or the first transmission indicated as new data that is received after a time period (e.g., time offset) from the indication (e.g., from the DCI or PDCCH that carries the indication). The WTRU may continue to use the current HARQ type for one or more retransmissions (e.g., for transmissions indicated as retransmissions). The WTRU may determine that a transmission is a retransmission based on an NDI included in the scheduling DCI for the transmission. For example, a retransmission may be indicated for a HARQ process when the NDI associated with the retransmission is not toggled (e.g., the value is the same as for the previous transmission).

An NDI may be applied to a HARQ process (e.g., the application may be done separately for different HARQ processes). For example, a WTRU may receive an indication of a HARQ type that is different than a current HARQ type for a first HARQ process and a second HARQ process. The WTRU may apply the indicated HARQ type to the first HARQ process (e.g., to transmissions associated with the first HARQ process) after new data is indicated for the first HARQ process. The WTRU may apply the indicated HARQ type to the second HARQ process (e.g., to transmissions associated with the second HARQ process) after new data is indicated for the second HARQ process (e.g., separately from the first HARQ process).

In examples, a WTRU may use an indicated HARQ type until a time period expires. The time period may begin when the WTRU receives the indication for the HARQ type, after a time delay (e.g., a configured time delay) from receiving the indication, or when the WTRU first applies the indicated HARQ type. When the time period ends, the WTRU may switch to using a previous HARQ type (e.g., the one it was using when it received the indication), a default HARQ type, or a configured HARQ type.

A HARQ type may be activated or deactivated. In an example, a WTRU may receive an indication to activate or deactivate the use of a HARQ type. The activation or deactivation may be received by the WTRU in a MAC CE or DCI, for example. If the WTRU receives the indication to activate the use of a HARQ type, the WTRU may use the activated HARQ type for one or more transmissions. For example, the WTRU may use the activated HARQ type for a first scheduled transmission and one or more (e.g., all) subsequent scheduled transmissions until the HARQ type is deactivated, until another HARQ type is activated, or until a time period (e.g., the T_{HAORP} described herein) expires.

The activation and/or deactivation of a HARQ type may be indicated or used for at least one of a specific cell, a group of cells, all cells, a specific HARQ process, a group of HARQ processes, or all HARQ processes. The WTRU may determine which transmission is the first transmission based on an indication included with the activation (e.g., a time offset), an application time or time offset that may be configured, and/or a condition (e.g., a new data condition). For example, the WTRU may receive an indication to activate a HARQ type and the WTRU may use (e.g., begin to use) the activated HARQ type for transmissions received or scheduled after a time period or time offset from the reception of the indication. The time period or time offset may be configured (e.g., via RRC signaling) or indicated with the activation of the HARQ type (e.g., in the MAC-CE or DCI that activates the HARQ type).

The WTRU may receive an indication to activate a HARQ type in a MAC-CE that may be carried by a PDSCH. The WTRU may use a current HARQ type for one or more (e.g., all) transmissions received by the WTRU prior to the WTRU sending HARQ feedback for the PDSCH that carries the activation MAC-CE. The WTRU may use the current HARQ type to transmit the HARQ feedback for the activation MAC-CE (e.g., for the PDSCH carrying the MAC-CE). The WTRU may apply the activated HARQ type after the WTRU sends an ACK for the activation MAC-CE. The WTRU may apply the activated HARQ type after a time period or time offset (e.g., which may be configured or indicated) expires from the time the WTRU sends the ACK for the activation MAC-CE.

The first transmission to which the WTRU applies an activated HARQ type (e.g., that is different from the current type being used) may be the first transmission (e.g., a PDSCH transmission) that satisfies one or more of the following conditions: the transmission is indicated as new data; the transmission is received after a time period (e.g., a time offset) from the activation of the HARQ type, where the time period may be configured or indicated (e.g., together with the activation); the transmission is after the WTRU transmits an ACK for a MAC-CE that activates the HARQ type.

The WTRU may continue to use a current HARQ type until the WTRU applies the activated HARQ type. The activation, indication, and/or application of a HARQ type may be treated separately for multiple HARQ processes. The activation, indication, and/or application of a HARQ type may be treated separately for multiple cells.

If the WTRU receives an indication to deactivate the use of a HARQ type, the WTRU may use a previous, default, or configured HARQ type for one or more transmissions received after the deactivation indication. The WTRU may use the previous, default, or configured HARQ type for a (e.g., any) transmission (e.g., a scheduled transmission) that occurs after the reception of the deactivation, for a (e.g., any) transmission (e.g., a scheduled transmission) that occurs after a time period or offset (e.g., which may be configured or indicated) from the deactivation indication or from the transmission of an ACK for the deactivation indication (e.g., which may be carried in a MAC-CE), and/or for a (e.g., any) transmission (e.g., a scheduled transmission) that occurs after the WTRU sends an ACK for the deactivating indication (e.g., which may be carried in a MAC-CE).

The first transmission to which the WTRU applies a HARQ type deactivation (e.g., the first transmission to which the WTRU uses a previous, default, or configured HARQ type) may be the first transmission of new data after the indication to deactivate the HARQ type is received. The first transmission may be the first transmission received after the deactivation indication, or the first transmission received after a time period or offset from the time the deactivation indication is received.

The deactivation of a HARQ type may be based on a timer or the expiry of a time period. For example, the WTRU may use an activated HARQ type until a time period expires. The time period may begin when the WTRU receives the activation of the HARQ type, after a time delay (e.g., the value of which may be configured) from the reception of the activation, and/or when the WTRU first applies the activated HARQ type. When the time period ends, the WTRU may use a previous HARQ type (e.g., the one it was using when receiving the activation indication), a default HARQ type, or a configured HARQ type.

A WTRU may request HARQ type switching (e.g., based on the WTRU's own measurement and/or prediction of conditions at or around the WTRU). Different HARQ types may be suitable for different times, for example, based on device, channel, and/or environmental conditions associated with those times. For example, TB-based HARQ feedback may be suitable for reducing HARQ overhead when channel conditions are favorable, and most transmissions are ACKed. As another example, CBG-based HARQ may be suitable for reducing latency and/or the overhead of multiple full TB transmissions when channel conditions are unfavorable, and many TBs are NACKed.

A WTRU may determine whether to request (e.g., recommend or suggest) a HARQ type change (or other HARQ overhead reduction techniques described herein) based on one or more parameters meeting corresponding triggering criteria (e.g., based on whether a parameter meets, exceeds, or falls below a threshold). The value of these parameters may be measured or predicted by the WTRU (e.g., current, actual or filtered RSRP, CLI, etc.). The parameter values may include the number of ACKs or NACKs that the WTRU has transmitted for a cell, a set of cells, a HARQ process, or a set of HARQ processes, and/or the number of ACKs or NACKs that the WTRU has transmitted over a time period, wherein the number may be based on an actual count or a predicted count of the ACKs or NACKs. The parameter values may include a percentage of ACKs or NACKs that the WTRU has transmitted over a time period, wherein the percentage may be an actual percentage (e.g., based on an actual count of the ACKs or NACKs) or a predicted percentage (e.g., based on a predicted count of the ACKs or NACKs). The parameter values (e.g., measurements) may be for a cell, a set of cells, a beam, or a set of beams. The percentage may be for a cell, a set of cells, a HARQ process, or a set of HARQ processes. In addition to or instead of sending the request for the HARQ type change, the WTRU may send one or more of the parameter values described herein (e.g., measurements, numbers, and/or percentages) to a base station, which may use one or more of these values to determine the HARQ type to indicate or activate for the WTRU.

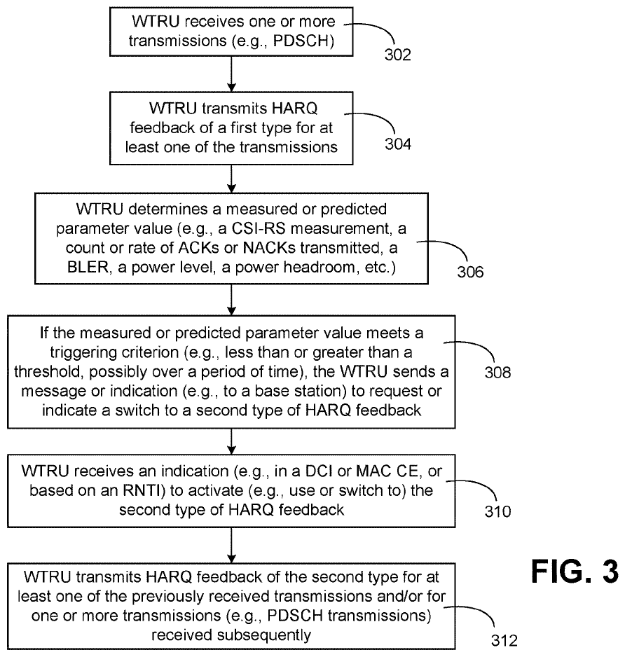

FIG. 3 illustrates an example of a WTRU requesting a HARQ type or a HARQ type change based on a determined parameter value meeting one or more triggering conditions. As shown in FIG. 3, the WTRU may receive one or more transmissions (e.g., PDSCH transmissions) from a base station at 302 and may transmit HARQ feedback of a first type (e.g., such as TB-based HARQ feedback) for at least one of the transmissions at 304. The WTRU may determine, at 306, a measured or predicted parameter value (e.g., such as a CSI-RS measurement result, a count or rate of ACKs or NACKs transmitted by the WTRU, a BLER, a power level, a power headroom, etc.). If the measured or predicted parameter value satisfies a triggering condition for requesting or switching to HARQ feedback of a second type (e.g., if the parameter value is less than or greater than a threshold, possibly over a period of time), the WTRU may send a message or indication to the base station at 308 to request or indicate a switch to the second type of HARQ feedback. The WTRU may (e.g., after sending the request) receive an indication from the base station at 310 to activate (e.g., use or switch to) the second type of HARQ feedback. As described herein, the indication may be received (e.g., explicitly indicated) via a DCI or MAC CE, or may be indicated based on an RNTI associated with a transmission (e.g., based on a RNTI, such as an RNTI associated with a DCI transmission, etc.). The indication may confirm the request from the WTRU to use or switch to the second HARQ type (e.g., CBG-based HARQ feedback, or a hybrid or mixture of TB and CBG-based HARQ feedback). At 312, the WTRU may apply the HARQ type (or another HARQ overhead reduction technique), requested by the WTRU or indicated by the base station, to one or more transmissions, e.g., after receiving the indication from the base station. The WTRU may apply the HARQ type (e.g., the requested HARQ type) that was indicated or activated as described herein (e.g., for actions related to HARQ type indication or activation). With respect to the indication to activate or switch to the confirmed HARQ type, and/or when to apply the confirmed HARQ type, receiving a confirmation may be considered the same as receiving an indication or an activation of (e.g., an indication to switch to or use) the HARQ type.

If the WTRU does not receive a confirmation, activation, or indication at 310 in response to the request sent by the WTRU, the WTRU may continue to use the HARQ type it was using before the request. If the WTRU receives an activation or indication for a different HARQ type than the one requested by the WTRU, the WTRU may apply the HARQ type that was actually indicated or activated as described herein (e.g., for actions related to HARQ type indication or activation).

A WTRU may receive configuration information regarding reference signals (RS) (e.g., such as CSI-RS resources, which may be associated with one or more beams) for measuring one or more channel and/or interference parameters (e.g., RSRP, CQI, SINR, RSSI, RI, hypothetical PDCCH BLER, LOS probability, etc.). The WTRU may receive configuration information and/or resources for reporting the measured parameters. The WTRU may receive a configuration of RS resources in one or more bandwidth parts (BWPs). For example, the WTRU may receive RS resources in a currently active BWP and in one or more inactive BWPs. As another example, the WTRU may receive a configuration of RS resources in one or more carriers and/or serving cells. The WTRU may determine to activate or deactivate a HAORP based on one or more measured CSI parameters (e.g., as described herein).

The WTRU may indicate, suggest, and/or request the activation or deactivation of a HAORP (e.g., to a base station) as part of a CSI report. In an example, the WTRU may receive an indication or configuration (e.g., via DCI, MAC-CE, RRC, etc.) that may enable or disable the WTRU to measure for or include the activation or deactivation of a HAORP as part of a CSI report. The WTRU may be configured to indicate the activation or deactivation of the HAORP periodically, semi-persistently, or aperiodically (e.g., via a periodic, semi-persistent, or aperiodic CSI report).

The WTRU may report or request the activation or deactivation of a HAORP and/or a time window during which the HAORP may stay activated or deactivated. In examples, after sending an indication (e.g., to a base station) regarding the activation of a HAORP, the WTRU may stop sending the indication for a determined or configured time window. In examples, after sending the indication regarding the activation of the HAORP, the WTRU may determine whether to deactivate the HAORP or keep the HAORP activated for a (e.g., each) round of CSI measurements based on the measurement results. The WTRU may send an indication to a base station with a (e.g., each) CSI report to confirm whether or not the HAORP may still be activated.

The WTRU may transmit (e.g., send or report) an indication of the activation/deactivation status of a HAORP along with a HARQ-ACK/NACK transmission, in addition to a HARQ-ACK/NACK transmission, in association with a HARQ-ACK/NACK transmission, and/or based on a HARQ-ACK codebook that may include one or more (e.g., additional) bits associated with certain information contents. An ACK transmission may be performed in response to the activation of a HAORP and an NACK transmission may be performed in response to the deactivation of the HAORP. Such an ACK transmission may be the last ACK transmission before the WTRU activates the HAORP and may serve as an indication to the base station that the WTRU is to activate the HAORP (e.g., in response to receiving a confirmation or command from the base station to activate the HAORP).

In examples, the WTRU may send a flag (e.g., a bit field) along with a HARQ-ACK/NACK transmission (e.g., in response to activation/deactivation of a HAORP) to indicate that the WTRU has measured one or more parameters (e.g., RSRP, BLER, etc.) and/or has determined to activate or deactivate the HAORP based on the measured parameters.

In examples, the WTRU may indicate, suggest, and/or report the activation or deactivation of a HAORP (e.g., to a base station) as part of another message and/or indication. For example, the WTRU may send a scheduling request (SR) (e.g., to a base station) for resources to send, report, and/or indicate the activation or deactivation of the HAORP. The SR may be a special SR or be sent in special resources to signal that the WTRU desires to activate/deactivate the HAORP.

In examples, the WTRU may send the indication regarding the activation or deactivation of a HAORP in addition to an indication regarding the resources (e.g., a component carrier (CC), a BWP, time and frequency resources, beam resources, a serving cell, etc.) for which the HAORP is activated or deactivated.

A handshake may be performed between a WTRU and a base station for dynamic HAORP activation/deactivation. For example, the WTRU may determine to activate or deactivate a HAORP and may indicate, suggest, request, and/or report the activation or deactivation of the HAORP to a base station (e.g., via a CSI report). The WTRU may receive a confirmation and/or indication from the base station indicating (e.g., approving) the activation or deactivation of the HAORP, the time duration associated with the activation or deactivation of the HAORP, the resources (e.g., CC) associated with the HAORP, etc.

A WTRU that has activated a HAORP may determine or be configured with one or more reference signals (e.g., CSI-RSs) and/or one or more thresholds associated with measurements (e.g., RSRP, Hypothetical BLER, SINR, etc.) of the reference signals. The WTRU may determine if the HAORP may be kept active based on the measurements, for example, by comparing the measurements with the thresholds. If a measured parameter is within an acceptable range of a corresponding threshold (e.g., an RSRP is larger than a corresponding threshold, a hypothetical BLER is lower than a corresponding threshold, etc.), the WTRU may determine, indicate, and/or report that the HAORP may be kept activated. If a measured parameter is not within an acceptable range of a corresponding threshold (e.g., an RSRP is lower than a corresponding threshold, a hypothetical BLER is higher than a corresponding threshold, etc.), the WTRU may determine, indicate, and/or report that the HAORP may be deactivated.

A WTRU that has activated a HAORP (e.g., for a time interval T_{HAORP}) may determine that an error rate (e.g., BLER) measured based on one or more DL transmissions is lower than a corresponding threshold. The WTRU may maintain the lower error rate in one or more of the following manners.

The WTRU may request, suggest, and/or indicate that the base station use one or more determined, reported, or pre-configured settings and/or parameters for DL transmissions associated with a HAORP. The requested settings and/or parameters may be related to one or more of an MCS, a DM-RS configuration, or a type of HARQ-ACK feedback. With respect to the MCS, the WTRU may request that the base station not change a determined MCS for a reported CQI and/or SINR. The WTRU may request that the base station not use a higher MCS (e.g., a MCS corresponding to lower coding rates and/or higher modulation levels) than a determined MCS for a reported CQI and/or SINR. With respect to DM-RS configuration information, the WTRU may request that the base station use the same DM-RS configuration (e.g., with respect to density, configuration type, etc.) during an indicated time window (e.g., T_{HAORP}). With respect to the type of HARQ-ACK feedback, the WTRU may request that the base station use TB-based HARQ-ACK feedback regardless of the possibility of using CBG-based HARQ-ACK and/or the possibility of using HARQ-ACK spatial multiplexing for a relevant cell or carrier.

The WTRU may request or suggest that the base station use one or more determined and/or pre-configured settings and/or parameters for DL transmissions associated with a HAORP (e.g., via a flag indication). The indication may indicate that the one or more determined or pre-configured settings and/or parameters may remain unchanged for DL transmissions associated with the HAORP. The WTRU may send the request explicitly or implicitly indicate the request along with a request for activation of the HAORP.

In examples, the WTRU may receive a feedback or confirmation indication from the base station in response to the WTRU sending a request or suggestion to activate a HAORP or use one or more determined and/or pre-configured settings and/or parameters for DL transmissions associated with the HAORP. If the base station receives a request to activate a HAORP (e.g., as part of a CSI report), the base station may expect the WTRU to perform predictions regarding the HAORP.

The WTRU may receive an indication from the base station that may confirm, partially accept, or reject the WTRU's request to activate/deactivate a HAORP. The indication may be an explicit indication or an implicit indication. For example, the WTRU may receive an explicit indication (e.g., via DCI, a MAC-CE, an RRC message, etc.) to activate, confirm, or deactivate the HAORP. The indication may indicate the acceptance or rejection of suggested, indicated, and/or reported settings and/or parameters for DL transmissions associated with the HAORP. The indication may be provided per DL scheduling event (e.g., via a DCI grant). For example, the WTRU may receive an indication from the base station regarding the activation or deactivation of a HAORP for one or more PDSCHs via a DCI that may schedule the one or more PDSCHs. As an example of an implicit indication, the WTRU may receive a scheduling grant with one or more parameters and/or settings that are different from the ones suggested, indicated, or reported by the WTRU. In response to receiving such a grant, the WTRU may determine that the base station has not accepted the parameters suggested by the WTRU. The WTRU may also implicitly determine whether or not the base station has accepted a request to activate a HAORP based on a set of received values. For example, if the base station has selected an MCS value that is higher than the value suggested by the WTRU, the WTRU may determine that the base station has rejected its request to activate the HAORP.

The WTRU may receive one or more updated values for a time interval associated with a HAORP. If the updated time duration is shorter than a time duration suggested by the WTRU, the WTRU may determine to deactivate the HAORP after the updated time duration expires (e.g., a corresponding timer expires). The WTRU may receive an updated list of carriers for which to apply the HAORP and the WTRU may determine that the base station has accepted to activate the HAORP for the updated list of carriers. The WTRU may determine that the base station has not accepted (e.g., has rejected) the request to activate the HAORP for the carriers that are not included in an update list of carriers. The WTRU may receive a priority indication associated with a (e.g., each) DL transmission (e.g., via a scheduling or grant DCI). The priority indication may indicate for which DL transmissions the HAORP may be activated or deactivated, and the WTRU may determine that the base station has accepted its request to activate the HAORP for the DL transmissions that satisfy the indicated priorities. The WTRU may determine that the base station has not accepted its request to activate the HAORP for transmissions that do not satisfy the indicated priorities.

A WTRU may determine to deactivate a HAORP for one or more transmissions (e.g., DL transmissions). For example, the WTRU may determine to deactivate the HAORP if the rate of failed DL transmissions (e.g., NACKs or consecutive NACKs) associated with the HAORP exceeds a determined and/or (pre)configured threshold. The WTRU may determine to deactivate the HAORP if the number of consecutive ACKs associated with the HAORP falls below a determined and/or pre-configured threshold. The WTRU may determine to deactivate the HAORP if one or more measured parameters are not within an acceptable range of corresponding thresholds (e.g., an RSRP is lower than a corresponding threshold, a hypothetical BLER is higher than a corresponding threshold, etc.).

The overhead associated with HARQ-ACK/NACK (e.g., downlink HARQ-ACK/NACK) transmissions may be reduced using AI/ML models. A WTRU may receive one or more transmissions for which the WTRU may be configured to report a HARQ-ACK or HARQ-NACK (HARQ-ACK/NACK). The WTRU may determine to enable/disable, use/stop using, or activate/deactivate a HAORP for a received DL signal (e.g., DL data) for a determined time duration (T_{HAORP}) based on a measurement, a prediction, and/or an explicit indication. With respect to the measurement, the WTRU may measure CSI based on configuration information associated with CSI-RS resources for channel and/or interference measurement and/or configuration information associated with CSI reporting in an active BWP. With respect to the prediction, the WTRU may use AI/ML models based on long-term observations and may obtain the predictions based on the output of the AI/ML models. The inputs to the AI/ML models may include a mobility status, a measured channel or interference parameter for one or more beam resources, etc. A condition for activating or deactivating a HAORP may be based on whether a channel condition tends to result in consecutive ACK or NACK transmissions, respectively. With respect to the explicit indication, the WTRU may receive an explicit indication (e.g., a higher layer parameter included in a SIB or RRC message) from a base station that a HAORP should be activated (e.g., the base station make the activation decision based on AI/ML models). If the WTRU determines that one or more conditions (e.g., consecutive ACKs, low mobility, low environmental traffic, etc.) may have occurred based on one or more measurements and respective thresholds associated with the measurements, the WTRU may trigger a report transmission to the base station and indicate the measurement results (e.g., mobility, channel conditions, BLER, traffic model, crowd, etc.) in the report. The base station may use the reported measurements to determine if a HAORP may be used by or activated/enabled for the WTRU. The explicit indication may be transmitted via DCI or a MAC CE.

The WTRU may indicate to the base station a request to use a HAORP. Examples of such an indication may include a persistent request (e.g., via an explicit or implicit indication included in a CSI report) from the WTRU to activate the HAORP and/or a handshake between the WTRU and the base station for dynamic HAORP activation. With respect to the persistent request, the WTRU may receive configuration information regarding CSI-RS resources (e.g., configuration information regarding CSI-RS resources for channel and interference measurement, and/or CSI reporting in an active BWP). The WTRU may indicate the HAORP activation request to the base station as part of a periodic, semi-persistent, or aperiodic CSI report, as part of a HARQ-ACK (e.g., enhanced with some flag indications), or by sending a flag indication (e.g., in a stand-alone message) to the base station requesting enablement of the HAORP. The indication may include a carrier indicator for which the HAORP may be performed. With respect to a handshake between the WTRU and the base station for dynamic HAORP activation, if the WTRU determines to perform the HAORP, the WTRU may request or suggest to the base station to use one or more pre-configured settings and/or parameters for corresponding DL transmissions. Such a request or suggestion may include a request not to change a determined MCS for the same reported CQI and/or SINR, a determined time duration to apply the HAORP (T_{HAORP}), a request for the base station to use TB-based HARQ feedback (e.g., despite possible CBG-based HARQ configuration and/or spatial multiplexing based HARQ configuration for a cell or carrier), etc. The WTRU may receive an indication from the base station (e.g., via DCI) that may confirm or reject the request for activating the HAORP. The indication may include a flag to enable/disable one or more of the aforementioned parameters and/or an updated value for the time interval and/or the carriers in which the HAORP may be applied. The indication may include a priority with which the HAORP may be activated/deactivated. The indication may be for one or more PDSCH receptions (e.g., the WTRU may receive an indication via a grant DCI to activate/deactivate the HAORP for a specific PDSCH grant). The indication may be received implicitly. For example, if the base station schedules the WTRU with a higher MCS, the WTRU may know that the base station may not approve the HAORP and that the WTRU may provide HARQ feedback in a legacy manner (e.g., in the manner adopted by the WTRU before sending the HAORP activation request).

The WTRU may build a HARQ-ACK codebook according to a HAORP. Examples of such a HAORP may include switching between TB-based HARQ feedback and CBG-based HARQ feedback, between TB-based HARQ feedback and a hybrid or mixture of TB-based and CBG-based HARQ feedback, etc. For example, a HAORP may be implemented by sending TB-based HARQ feedback instead of CBG-based HARQ feedback or spatial multiplexing based HARQ feedback. The WTRU may be configured with PUCCH resources for TB-based feedback. The WTRU may determine to use TB-based HARQ feedback or CSBG-based HARQ feedback based on whether a cell-based flipping or WTRU-based flipping (e.g., only for the WTRU) between different HARQ types is activated, based on whether multiple cells/carriers are operating in carrier aggregation or only one of the cells/carriers is in operation, and/or based on whether the HARQ feedback is for new data transmissions or for both new data transmissions and retransmissions. The WTRU may transmit a HARQ-ACK codebook for one or more received transmissions.

One or more codebooks may be enhanced for HARQ overhead reduction. A WTRU may determine to enable, use, or activate a HAORP (e.g., based on AI/ML models and/or an indication from a base station) for a time duration (T_{HAORP}). The WTRU may determine to generate and/or use a codebook for HARQ feedback transmissions. The codebook may include TB-based HARQ feedback bits (e.g., in a first part of the codebook) followed by CBG-based HARQ feedback bits or partial CBG-based HARQ feedback bits (e.g., in a second part of the codebook). When referred to herein, “partial CBG-based HARQ feedback” may mean HARQ feedback for a subset of CBGs (e.g., not all CBGs) received by the WTRU (e.g., the subset of CBGs for which a corresponding TB has been NACKed). To generate such a codebook, the WTRU may determine the PDSCH(s) and/or PDCCH(s) for which a HARQ-ACK/NACK transmission is to be included in the codebook. The determination may be made, for example, based on respective values of K1 and/or respective time limits associated with the PDSCH(s) and/or PDCCH(s). For instance, a K1 value may indicate the offset between the DL slot in which a DL transmission is scheduled and the UL slot in which HARQ ACK/NACK feedback for the DL transmission should be sent. As such, HARQ ACKs/NACKs scheduled in the same set of UL resources (e.g., as indicated by K1 values) may indicate to the WTRU that those HARQ ACKs/NACKs can be merged in a single codebook.

The codebook (e.g., comprising TB-based HARQ feedback bits followed by partial CBG-based HARQ feedback bits) may include two parts. The first part may be a compressed part or version (e.g., TB-based) comprising HARQ information bits associated with one or more PDCCH/PDSCH receptions (e.g., the first part of the codebook is compressed in the sense that TB-based HARQ feedback includes fewer bits than CBG-based HARQ feedback). In examples, the first part of the codebook may include a bitmap corresponding to one or more HARQ processes, wherein each bit of the bitmap may represent a TB-based HARQ information bit for a PDCCH/PDSCH received during a configured and/or determined time interval (T_{HAORP}) (e.g., each bit of the bitmap may be calculated based on a logical AND of multiple (e.g., all) HARQ-ACK bits associated with a HARQ process or a TB). The WTRU may generate HARQ information for (e.g., only for) transport block(s) associated with the PDSCH, for (e.g., only for) an SPS PDSCH release, or for (e.g., only for) a TCI state update. The order of bits in the aforementioned bitmap may be based on the reception times (e.g., according to semi-static configurations or DAI in dynamic configurations) of the PDCCH/PDSCH transmissions for which the HARQ feedback is provided, or based on the HARQ process indices associated with the PDCCH/PDSCH transmissions for which the HARQ feedback is provided (e.g., the bits of the bitmap may be arranged in an ascending order from MSB to LSB according to the HARQ process indices). Multiple PDSCH transmissions may be associated with the same HARQ process, so the order of the bitmap may be different depending on whether the order is based on reception times or HARQ process indices. For each bit of the bitmap, a value of 1 may indicate an ACK while a value of 0 may indicate an NACK.

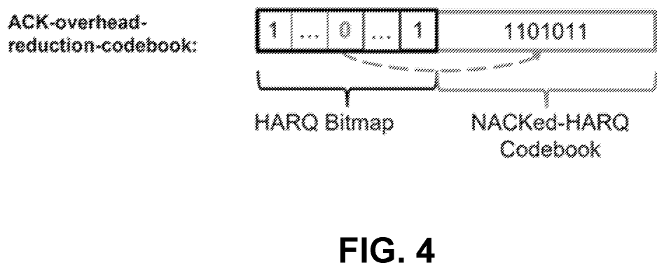

The second part of the codebook described herein may include HARQ feedback bits and/or codebooks for (e.g., only for) HARQ processes that are NACKed in the first part of the codebook (e.g., in the bitmap described herein), as illustrated by FIG. 4. One or more of the following operations may be performed with respect to the second part of the codebook. For a HARQ process associated with a transport block (e.g., for PDCCH monitoring occasion m or for SPS PDSCH receptions on serving cell c), if the corresponding HARQ feedback bit in the first part of the codebook (e.g., the bitmap) indicates an ACK, the WTRU may not multiplex HARQ-ACK information bits corresponding to the transport block in the second part of the codebook. Further, if the WTRU is provided with PDSCH-CodeBlockGroupTransmission, the WTRU may not multiplex HARQ-ACK information bits corresponding to CBGs of the ACKed transport block in the codebook. If the corresponding HARQ information bit in the first part of the codebook (e.g., the bitmap) indicates an NACK, the WTRU may generate HARQ feedback bits for the transport block in the second part of the codebooks (e.g., one HARQ feedback bit per CBG associated with the NACKed TB), and may do so on a per HARQ process basis (e.g., the HARQ generation for one HARQ process may be separate from another HARQ process). In examples, the WTRU may construct the codebook (e.g., comprising TB-based HARQ bits followed by partial CBG-based HARQ bits) by concatenating the determined HARQ-ACK bits and/or codebooks (e.g., in an ascending order of HARQ process IDs or reception times). The codebook may be constructed per serving cell, or for multiple (e.g., all) of the serving cells, configured for the WTRU.

The first part and the second part of the codebook (e.g., the first part comprises TB-based HARQ feedback, and the second part comprises partial CBG-based HARQ feedback) may be transmitted separately (e.g., in two parts) based on one or more of the following. A TB-based (e.g., which may be referred to herein as Type 2 or Type II) HARQ codebook and a partial CBG-based (e.g., which may be referred to herein as Type 3 or Type III) codebook may be combined. The WTRU may be configured with first PUCCH resources (e.g., via a grant DCI) to send HARQ feedback. The WTRU may send the first part of the codebook (e.g., the TB-based bitmap) using the configured first PUCCH resources. Subsequently, the WTRU may receive a request from a base station to perform a transmission (e.g., a one-shot transmission as described herein) of the second part of the codebook (e.g., partial CBG-based HARQ feedback). In examples, the request from the base station may indicate second PUCCH resources for performing the one-shot transmission. In examples, the request from the base station may indicate a corresponding bitmap (e.g., bitmap #1, #2, etc.). In examples, the request from the base station may include a request for HARQ codebook Type 3.

The WTRU may be configured with PUCCH resources (e.g., via a grant DCI) to send HARQ feedback. The PUCCH resources may include enough resources for transmitting the TB-based HARQ bitmap described herein (e.g., the first part of the codebook), followed by resources only enough for transmitting a subset (e.g., N CBG-based HARQ transmissions) of the information contained in the second part of the codebook. If the number of CBG-based HARQ transmissions in the second part of the codebook is lower than N, the WTRU may send the first and second parts of the code book using the indicated PUCCH resources. If the number of CBG-based HARQ transmissions in the second part of the codebook is higher than N, the WTRU may send the first part of the codebook and the first N CBG-based HARQ transmissions of the second part of the codebook using the configured PUCCH resources (e.g., the remaining CBG-based HARQ transmissions of the second part of the codebook may not be sent with the configured PUCCH resources). Later, the WTRU may receive a request (e.g., a Type 3 HARQ codebook request) from the base station to send the remaining CBG-based HARQ transmissions. The base station may retransmit the data for the HARQ processes, PDSCHs, and/or PDCCHs NACKed in the first part of the codebook (e.g., in the bitmap) and for which CBG-based HARQs have not yet been transmitted. The value of N may be determined and/or reported by the WTRU (e.g., based on AI/ML prediction models). The value of N may also be determined and configured (e.g., for the WTRU) by the base station.

A WTRU may be configured (e.g., by a base station) to generate and/or transmit an enhanced codebook associated with HARQ feedback (referred to herein as a HARQ-ACK codebook). Such a HARQ-ACK codebook may be based on TB-based HARQ feedback, followed by CBG-based (e.g., partial CBG-based) HARQ feedback. The WTRU may be configured to generate and/or transmit the HARQ-ACK codebook to enable, use, or activate a HAORP, as described herein. In an example, the WTRU may receive an indication to include one or more ACK/NACK (e.g., information bits) in the HARQ-ACK codebook associated with one or more of the following entities, processes, parameters, and/or configurations. These entities, processes, parameters, and/or configurations are non-limiting examples of the entities, processes, parameters, and/or configurations that may be used for generating information bits for the HARQ-ACK codebook. One or more of these entities, processes, parameters, and/or configurations may be included. Other entities, processes, parameters, and/or configurations may also be included. The entities, processes, parameters, and/or configurations may include one or more HARQ processes, one or more component carriers (CC) associated with a PUCCH group, one or more SPS PDSCH receptions configured for one or more serving cells, in one or more active BWPs, over one or more DL slots for SPS PDSCH receptions (e.g., configured to be multiplexed in a corresponding PUCCH), one or more CBG-level ACKs/NACKs for a CC with CBG-level transmission configured, one or more configured (e.g., SPS) PDSCH receptions, SPS PDSCH releases, or TCI state updates, one or more group DCI formats (e.g., DCI with CRC scrambled by a G-RNTI or a G-CS-RNTI, high priority group DCI, etc.), the detection of one or more DCI formats (e.g., associated with TCI state updates) with or without a scheduling PDSCH reception, etc.

The WTRU may report, suggest, or indicate the use of the HARQ-ACK codebook (e.g., TB-based HARQ followed by CBG-based HARQ). The WTRU may determine, indicate, or report a time window (e.g., T_{HAORP}) for using the HARQ-ACK codebook. The WTRU may receive an indication (e.g., from the base station) to enable the use of the HARQ-ACK codebook and/or the time window for using the HARQ-ACK codebook. The WTRU may receive the indication via DCI, a MAC-CE, and/or RRC signaling from the base station. The time window included in the indication for using the HARQ-ACK codebook may be the same as the time window recommended by the WTRU or be changed by the base station (e.g., based on the WTRU's recommendation).

In examples, the WTRU may receive a confirmation message, an activation indication, and/or the time window associated with the use of the HARQ-ACK codebook as part of HARQ-ACK configuration information (e.g., in the PDCCH), or as a separate message or indication (e.g., which may be received via DCI, MAC-CE, RRC, etc.).

In examples, the WTRU may be configured to generate the HARQ-ACK codebook for (e.g., only for) DL transmissions (e.g., PDCCH, PDSCH, etc.) whose grant indication (e.g., received via DCI) includes a confirmation message or an indication to activate the use of the HARQ-ACK codebook.

In examples, the WTRU may be configured to generate the HARQ-ACK codebook for multiple (e.g., all) DL transmissions (e.g., PDCCH, PDSCH, etc.) received from the time of the indication to the end of the configured time window (e.g., T_{HAORP}).

In examples, the confirmation message or indication may include an indication (e.g., a flag or bit field) to activate/deactivate or enable/disable the use of the HARQ-ACK codebook (e.g., via a flag indication in DCI, MAC-CE, RRC, etc.). In examples, the confirmation message or indication may indicate serving cells, component carriers, and/or HARQ processes for an indicated serving cell that may be associated with the HARQ-ACK codebook. In examples, the confirmation message or indication may include the time window (e.g., T_{HAORP}) for using or applying the HARQ-ACK codebook.

In examples, the WTRU may generate the HARQ-ACK codebook for multiple (e.g., all) of the DL transmission for which the HARQ-ACK codebook is activated and/or for which corresponding HARQ-ACK feedback is configured to be transmitted in the same (UL) resources (e.g., as indicated by K1 values). For instance, the WTRU may receive a number of (e.g., N) DL transmissions (e.g., PDCCH, PDSCH, etc.) for which HARQ-ACK configuration information may indicate that the same time and/or frequency resources (e.g., as indicated by K1 values) may be used to send HARQ-ACK feedback. The WTRU may then generate the HARQ-ACK codebook for these (e.g., N) received DL transmissions.

To determine the number of DL transmissions associated with the HARQ-ACK codebook, the WTRU may consider DL transmissions received from the time HARQ-ACK codebook generation was activated to the end of a pre-configured time gap (e.g., T_{HARQ-K1-gap}) for using configured (UL) resources (e.g., PUCCH resources) to send the HARQ-ACK codebook (e.g., the time gap may be between reception of the DL transmissions and transmission of the HARQ-ACK codebook using the configured UL resources). In examples, the WTRU may not expect to receive UL resources for HARQ-ACK feedback transmission (e.g., PUCCH resources) within such a time gap (e.g., T_{HARQ-K1-gap}).

The WTRU may generate one or more HARQ-ACK information bits for a (e.g., each) HARQ process ID, where a (e.g., each) HARQ information bit in the codebook may represent an ACK/NACK for a received DL transmission (e.g., one bit per TB or CBG) corresponding to the HARQ process ID. In an example,

$${\tilde{o}}_{0}^{A C K} , {\tilde{o}}_{1}^{A C K} , … , {\tilde{o}}_{{O}_{ACK} - 1}^{A C K}$$

may indicate the HARQ-ACK information bits for a total number O_{ACK} of HARQ-ACK information bits for the corresponding HARQ process ID. In an example, for a received PDSCH, the corresponding HARQ-ACK information bits may represent TB-based or CBG-based HARQ information bits. In an example, for a received SPS PDSCH release or a received TCI state update, the HARQ information bits may indicate the ACK/NACK of the reception of the corresponding message.

As described herein, the HARQ-ACK codebook may include at least two parts. The first part of the HARQ-ACK codebook may be a compressed part or version of HARQ-ACK information bits and/or HARQ-ACK codebook(s) associated with one or more received DL transmissions. In an example, the WTRU may be configured to generate the HARQ-ACK codebook for a received PDSCH. The WTRU may calculate, generate, and/or determine the first part of the HARQ-ACK codebook corresponding to the PDSCH according to the HARQ-ACK information bits and/or codebook that may be generated based on an acknowledged or not-acknowledged (e.g., faulty) reception of transport block(s) for the PDSCH. The WTRU may receive a PDSCH that may include one or more code block groups (CBGs) associated with a transport block, and the WTRU may calculate, determine, and/or report HARQ-ACK information bits for the transport block in the first part of the HARQ-ACK codebook.

The WTRU may generate the first part of the HARQ-ACK codebook as a bitmap, where each bit in the bitmap may be calculated based on TB-based HARQ-ACK feedback corresponding to a HARQ process ID, as illustrated by FIG. 4. The order of the bits in the bitmap may be based on HARQ process IDs and/or reception times of the transport blocks for which the HARQ feedback is being provided. With the HARQ process ID based ordering, HARQ bits corresponding to the HARQ process indices may be mapped in an ascending order from MSB to LSB of the bitmap based on the HARQ process indices. Each bit in the bitmap may correspond to a HARQ process ID (e.g., one bit may be generated for each TB associated with the HARQ process ID) and the length of the bitmap may be equal to the number of HARQ process IDs associated with the DL transmissions for which the HARQ feedback is being provided. With the reception time based ordering, each bit in the bitmap may correspond to a HARQ-ACK information bit associated with a HARQ process ID, and the order of the bits may be based on the reception times of the DL transmissions for which the HARQ feedback is being provided.

In an example, each bit of the bitmap described herein may include a first value (e.g., 1, indicating an ACK) or a second value (e.g., 0, indicating an NACK). In an example, the WTRU may be configured to generate the HARQ-ACK codebook based on the reception of a number of (e.g., N) DL transmissions (e.g., PDCCH, PDSCH, etc.), where the HARQ-process IDs for the DL transmissions may be indicated (implicitly or explicitly) in respective grant messages. The WTRU may generate HARQ-ACK information bits for the received DL transmissions using the TB-based HARQ-ACK mechanism described herein. The WTRU may generate the bitmap in a first part of the HARQ-ACK codebook, where the size of the bitmap may be equal to the total number of received HARQ process IDs (each bit in the bitmap may correspond to the reception of a DL transmission associated with a configured HARQ process ID). The WTRU may be configured to order the bits in the bitmap based on the reception times of the DL transmissions or based on the HARQ process IDs associated with the DL transmissions.

The WTRU may compress the bitmap included in the first part of the HARQ-ACK codebook. In an example, the WTRU may be configured with a compression rate for the bitmap. In an example, the WTRU may determine the compression rate for the bitmap based on an acceptable rate of error (e.g., BLER) that may be received as part of the configuration information regarding the HARQ-ACK codebook. The WTRU may use a higher compression rate for scenarios with higher acceptable error rates (e.g., eMBB) and may use a lower compression rate for scenarios with lower acceptable error rates (e.g., URLLC). The base station may decompress the compressed first part of the HARQ-ACK codebook to determine the first part of the HARQ-ACK codebook (e.g., to determine the bitmap described herein).

The WTRU may generate the second part of the HARQ-ACK codebook using the CBG-based HARQ feedback mechanism described herein (e.g., partial CBG-based HARQ transmission or reporting mechanism). For example, the WTRU may generate and report CBG-based HARQ feedback for (e.g., only for) a PDSCH transmission for which TB-based HARQ information bit(s) in the first part (e.g., bitmap) of the HARQ-ACK codebook indicates a NACK (e.g., as illustrated by FIG. 4). In examples, for a HARQ process associated with a transport block for PDCCH monitoring occasion m or for SPS PDSCH receptions on serving cell c, if a corresponding bit in the first part of the HARQ-ACK codebook (e.g., in the bitmap described herein) indicates an ACK, the WTRU may not multiplex a HARQ-ACK information bit corresponding to the transport block in the second part of the HARQ-ACK codebook. In examples, if the WTRU is configured with CBG-based HARQ transmission (e.g., via PDSCH-CodeBlockGroupTransmission), the WTRU may not multiplex HARQ-ACK information bits corresponding to the CBGs of the transport block in the second part of the HARQ-ACK codebook. In examples, if a corresponding bit in the first part (e.g., bitmap) of the HARQ-ACK codebook indicates NACK, the WTRU may generate HARQ-ACK bits and/or codebooks for the corresponding HARQ process and/or CBGs in the second part of the HARQ-ACK codebook by concatenating the determined HARQ-ACK bits and/or codebooks (e.g., in an ascending order based on the HARQ process IDs, based on the reception times of the DL transmissions, etc.).

The WTRU may determine an association between the HARQ-ACK information bits in the first part (e.g., bitmap) of the HARQ-ACK codebook and the (e.g., concatenated) HARQ-ACK bits and/or codebooks in the second part (e.g., CBG-based) of the HARQ-ACK codebook. The WTRU may determine the association based on a corresponding HARQ-ACK process ID between the two parts. The WTRU may determine the order of the generated and/or reported HARQ-ACK information bits in the second part (e.g., CBG-based HARQ-ACK) of the HARQ-ACK codebook to follow the order of the HARQ-ACK bits in the first part (e.g., bitmap) of the HARQ-ACK codebook, where the HARQ-ACK codebooks and/or information bits may be included in the second part (e.g., CBG-based HARQ-ACK) of the HARQ-ACK codebook if (e.g., only if) a corresponding HARQ-ACK bit in the first part (e.g., bitmap) of the HARQ-ACK codebook indicates an NACK.

If the base station receives the HARQ-ACK codebook described herein, the base station may check the first part of the codebook and determine faulty DL transmissions based on the TB-based NACK bits included in the first part (e.g., bitmap) of the codebook. Based on the NACK bits in the first part of the HARQ-ACK codebook, the base station may decode the CBG-based HARQ-ACK information bits or codebooks included in the second part of the HARQ-ACK codebook (e.g., in the same order as the NACK indications or bits included in the first part of the HARQ-ACK codebook).

A WTRU may be configured to transmit the HARQ-ACK codebook described herein (e.g., a new or enhanced HARQ-ACK codebook) in multiple (e.g., two) parts or steps. The WTRU may provide HARQ ACK/NACK feedback with first information, second information, and third information. In examples, the first information may include ACK/NACK information for certain HARQ process indices. For instance, the WTRU may generate (e.g., as part of the first information) a bitmap in which a (e.g., each) bit may represent an ACK/NACK for a HARQ process. The bit may be calculated based on an AND function on multiple (e.g., all) HARQ-ACK bits corresponding to the HARQ process. In examples, the second information may include HARQ ACK bits and/or codebooks for (e.g., only for) HARQ processes that may be NACKed in the first information. In examples, the second information may include HARQ ACK bits associated with CBG(s) for (e.g., only for) the HARQ processes NACKed in the first information. In examples, the second information may include HARQ bits and/or codebooks for (e.g., only for) HARQ processes NACKed in the first information, and the third information may include HARQ bits for CBGs associated with (e.g., only with) TBs NACKed in the second information. In this way, the HARQ codebook described herein may be constructed in a hierarchical manner.

The WTRU may report the HARQ ACK/NACK information in one or more uplink (UL) (e.g., PUCCH and/or PUSCH) transmissions. For example, the HARQ ACK/NACK information may be transmitted in a same slot or in different slots. Resources for the HARQ ACK/NACK transmission may be configured and/or indicated via RRC signaling, a MAC CE, and/or DCI (e.g., a WTRU-specific DCI for scheduling one or more PUSCHs or a group DCI).

In examples, the WTRU may report the HARQ ACK/NACK information in a single UL transmission. For example, the WTRU may report the first information and the second information described herein in a single UL transmission (e.g., a single UL signal and/or channel). In these examples, the payload size of the first information may be based on the number of HARQ processes reported. The payload size of the second information may be based on a predetermined or preconfigured number of bits. For example, the payload size of the second information may be based on the number of HARQ processes multiplied by a maximum number of bits associated with each HARQ process.

In examples, the WTRU may report the HARQ ACK/NACK information in multiple parts (e.g., in two or more UL transmissions). For example, the WTRU may report the first information described herein as a first part using a first resource, the second information described herein as a second part using a second resource, and the third information described herein as a third part using a third resource. The payload size of the first information may be based on the number of HARQ codebooks reported. The payload size of the second information may be determined based on a number of bits associated with NACKed HARQ processes in the first information. For example, the payload size of the second information may be based on the number of NACKed HARQ processes*the number of bits associated with each NACKed HARQ codebook. The payload size of the second information and/or the third information may be determined based on the number of bits associated with NACKed TBs in the first or second information. For example, the payload size of the second or third information may be based on the number of NACKed TBs*the number of bits for each NACKed TB (e.g., the number of CBGs for each NACKed TB).

The configuration or indication of resources for transmitting the first part, the second part, or the third part of the HARQ ACK/NACK information may be different. For example, UL resources for the first part may be semi-statically configured (e.g., via RRC and/or MAC CE), while UL resources for the second part may be dynamically indicated (e.g., via a DCI indication of an UL resource from one or more UL resources semi-statistically configured via RRC and/or MAC CE). The number of configured or indicated UL resources may be different for the first part, the second part, and the third part. For example, the number of UL resources for the first part may be one resource while the number of UL resources for the second part may be two or more resources. The WTRU may select an UL resource from the two or more configured resources based on one or more of a modulation scheme, a coding rate, an interference level, a channel quality (e.g., one or more of SINR, RSRP, CQI, etc.), a number of NACKed processes and/or NACKed TBs, and/or the like.

The same or different UL resources may be used to transmit the first, second, and third information described herein. For example, the WTRU may transmit the first information in a first transmission using a first resource, the second information in a second transmission using a second resource, and the third information in a third transmission using a third resource. The WTRU may determine whether or not to transmit the first information, the second information, and the third information using the same resource(s). For example, if one or more parameters have values less than a threshold (e.g., which may be configured or indicated via one or more of RRC, MAC CE, or DCI and/or reported by the WTRU), the WTRU may use the same resource(s) to transmit two or more of the first information, the second information, or the third information. Otherwise, the WTRU may use different resources to transmit the information. The one or more parameters may include one or more of a number of failed HARQ codebooks, a number of failed TBs, a number of failed CBGs, a number of HARQ codebooks to be reported, a number of TBs to be reported (e.g., determined based on NACKed HARQ codebooks), a number of CBGs to be reported (e.g., based on NACKed TBs), etc.

Codebook generation may be enhanced to support HARQ-ACK overhead reduction. A WTRU may determine to enable/disable, use/stop using, or activate/deactivate a HAORP (e.g., based on an AI/ML model prediction, a measurement, or an explicit indication from gNB), for a determined time duration (T_{HAORP}). The WTRU may receive one or more transmissions for which it is configured to report a HARQ-ACK/NACK. When generating a codebook (e.g., a new codebook), the WTRU may determine the PDSCHs and/or PDCCHs for which a HARQ-ACK transmission may be included in the codebook based on their respective K1 values (e.g., mapping to the same PUCCH resources) and/or respective time limits. The WTRU may determine to use a two-part codebook (e.g., TB-based HARQ feedback followed by CBG-based HARQ feedback including partial CBG-based HARQ feedback) for the HARQ-ACK feedback. The WTRU may build the two-part codebook in one or more of the following manners.

The two-part codebook (e.g., TB-based HARQ feedback followed by partial CBG-based HARQ feedback) may be formed based on two sets of HARQ bits. The first set of HARQ bits may include a compressed set or version (e.g., TB-based) of HARQ information bits that may correspond to one or more PDCCH/PDSCH receptions. The first set of HARQ bits may include a bitmap associated with one or more HARQ processes, in which a (e.g., each) HARQ bit in the bitmap may represent a TB-based HARQ information bit for a received PDCCH/PDSCH in a configured and/or determined time interval (T_{HAORP}). For example, a (e.g., each) HARQ bit may be calculated based on a logical AND function of multiple (e.g., all) HARQ bits corresponding to a HARQ process. The WTRU may generate HARQ information for (e.g., only for) a transport block in the PDSCH, for (e.g., only for) an SPS PDSCH release, or for (e.g., only for) a TCI state update. The order of bits in the bitmap may be based on reception times (e.g., based on the order in which the PDCCHs/PDSCHs are received in time as indicated by semi-static configurations or downlink assignment indexes (DAIs) in dynamic configurations). The order of the bitmap may be based on HARQ process IDs or indices (e.g., the bits may be ordered in an ascending order from MSB to LSB of the bitmap in accordance with the corresponding HARQ process indices). For a (e.g., each) HARQ bit of the bitmap, a value of 1 may indicate an ACK and a value of 0 may indicate an NACK.

The second set of HARQ bits may include HARQ bits and/or codebooks for (e.g., only for) the HARQ-processes that were NACKed in the first set of HARQ bits. For example, for a HARQ process associated with a transport block for PDCCH monitoring occasion m or for SPS PDSCH receptions on serving cell c, if the corresponding bit in the first set of HARQ bits indicates an ACK, the WTRU may not include HARQ information bits corresponding to the transport block in the second set of HARQ bits of the two-part codebook. If the WTRU is configured with PDSCH-CodeBlockGroupTransmission (or a similar parameter), the WTRU may not multiplex HARQ information bits corresponding to the CBGs of the transport block in the second set of HARQ-ACK bits of the two-part codebook. If the WTRU is not configured with PDSCH-CodeBlockGroupTransmission (or a similar parameter) and if the corresponding bit in the first set of HARQ-ACK bits indicates an NACK, the WTRU may include one or more HARQ information bits corresponding to the transport block (e.g., for CBGs of the transport block) in the set of HARQ bits of the two-part codebook. The WTRU may determine the second set of HARQ bits, for example, by concatenating the relevant HARQ information bit(s) (e.g., based on an ascending or descending order of the corresponding process IDs or reception times associated with a transport block).

The WTRU may determine the two-part codebook (e.g., a TB-based HARQ followed by a partial CBG-based HARQ) by concatenating the first set of HARQ bits and the second set of HARQ bits. The two-part codebook may be constructed per serving cell or for multiple (e.g., all) serving cells configured for the WTRU.

The WTRU may transmit the two-part codebook in one or more of the following manners. In a first manner of transmission, the first set of HARQ bits and the second set of HARQ bits in the two-part codebook (e.g., a TB-based HARQ followed by a partial CBG-based HARQ) may be transmitted in two parts or steps. For example, the two-part codebook may include a TB-based Type 2 HARQ codebook combined with a partial CBG-based Type 3 codebook. The WTRU may receive a configuration of first resources (e.g., PUCCH resources indicated via grant DCI) for sending HARQ feedback and the WTRU may send the first set of HARQ bits of the two-part codebook (e.g., the TB-based bitmap) using the configured first PUCCH resources. The WTRU may subsequently receive a grant from a base station indicating second PUCCH resources for performing a transmission (e.g., a one-shot transmission) of the second set of HARQ bits of the two-part codebook.

In a second manner of transmission, the WTRU may receive a configuration of PUCCH resources for sending a HARQ feedback (e.g., via a grant DCI). The PUCCH resources may include enough resources for transmission of the first set of HARQ bits and only N bits of the second set of HARQ bits. If the size of the second set of HARQ bits is smaller than N, the WTRU may send the first and second sets of HARQ bits in the indicated/configured PUCCH resources. If the size of the second set of HARQ bits is more than N, the WTRU may send the first set of HARQ bits and the first N bits of the second set of HARQ bits with the indicated/configured PUCCH resources. The WTRU may (e.g., later) receive a request for a Type 3 HARQ codebook from the base station (e.g., to send the remaining portion of the second set of HARQ bits), and/or a grant of resources for the Type 3 HARQ codebook. In response, the WTRU may transmit the requested Type 3 HARQ codebook (e.g., the remaining portion of the second set of HARQ bits) to the base station using the grant of resources. The value of N may be determined and/or reported by the WTRU (e.g., based on AI/ML prediction models). The value of N may be determined and/or configured by the base station.

The HARQ codebook described herein may be transmitted via a one-shot transmission (e.g., delay and/or accumulate HARQ information, and transmit the delayed/accumulated HARQ information at once). As described herein, a WTRU may determine to enable, use, or activate an HAORP based on an AI/ML model, a measurement performed by the WTRU, or an indication (e.g., an explicit indication) from a base station. The WTRU may determine to transmit a HARQ codebook (e.g., comprising TB-based HARQ feedback information followed by partial CBG-based HARQ feedback information) associated with DL transmissions in a one-shot transmission (e.g., delay HARQ feedback until the one-shot transmission) over one or more carriers. One or more of these operations may result in power saving and/or avoidance of frequent switching between the DL and UL.

The WTRU may send a message to the base station (e.g., as part of a CSI report or HARQ-ACK transmission) and may indicate (e.g., via a flag or a bit field) a request for enabling a one-shot transmission of a HARQ codebook and/or a carrier associated with the request. The WTRU may receive a confirmation or an indication from the base station (e.g., via a PDCCH transmission) to enable delayed transmission of HARQ-ACK feedback until the one-shot transmission of the HARQ codebook. The confirmation or indication from the base station may indicate a carrier for which the one-shot HARQ codebook transmission is configured/confirmed. The confirmation or indication from the base station may include a non-numerical (NN) K1 value (e.g., also referred to herein as an invalid K1 value) that may indicate an invalid or empty resource allocation.

The enablement of the one-shot transmission of the HARQ codebook (e.g., delayed HARQ-ACK feedback) may be provided via an explicit indication such as a field in DCI indicating that the base station has accepted the request from the WTRU to enable the one-shot transmission. The enablement may also be provided implicitly, e.g., via a PUCCH resource indicator. For example, a value of 0 in such an indicator may indicate that no PUCCH resources has been allocated for HARQ feedback or that the base station has accepted the one-shot HARQ-ACK transmission. As another example, an invalid K1 value in such an indicator may indicate that the base station has accepted the one-shot HARQ feedback transmission.

The WTRU may receive a grant or configuration (e.g., via DCI) associated with the reception of a PDCCH, SPS-PDSCH, TCI state update, dynamic grant for PDSCH, etc. The grant or configuration may include corresponding HARQ-ACK/NACK parameters such as a HARQ process ID, a HARQ codebook type, spatial bundling, CBG transmissions, etc. The WTRU may receive scheduled DL transmissions and may determine HARQ feedback bits or codebooks (e.g., based on the codebook generation techniques described herein) corresponding to the DL transmissions. The WTRU may decide not to transmit the HARQ feedback or codebooks and instead to buffer or store TB-based HARQ feedback (e.g., a bitmap as a first part of the codebook) and/or CBG-based HARQ feedback (e.g., as a second part of the codebook). If the WTRU receives a PDCCH transmission (e.g., a grant DCI) with a valid K1 value, the WTRU may stop the buffering of the HARQ feedback (e.g., HARQ codebook) and use the corresponding PUCCH resources to transmit the stored/buffered HARQ feedback (e.g., HARQ codebook). The WTRU may determine and/or indicate to the base station that the buffering of the HARQ codebook may be deactivated or stopped for the one-shot HARQ transmission. The deactivation may be based on one or more of an AI/ML model, a buffer size (e.g., the WTRU may determine that there may not be enough buffer space left), or an RTT (e.g., the WTRU may determine that further delaying of HARQ-ACK/NACK transmission may exceed a configured maximum RTT). With the AI/ML model, the WTRU may predict and/or determine (e.g., based on base station indications) that consecutive ACKs may no longer be possible and/or that the number of NACKs may be increasing. As a result, HARQ feedback should no longer be delayed. The deactivation indication (e.g., to stop the buffering of HARQ-ACK/NACK and perform a one-shot transmission of the HARQ-ACK codebook) may include a flag or bit field (e.g., as part of a CSI report). The indication may serve as a scheduling request for transmission of the HARQ codebook.

The HAORP described herein may include transmission (e.g., a one-shot transmission) of a HARQ codebook (e.g., the enhanced HARQ-ACK codebook described herein) by a WTRU. Such a HARQ codebook may include two or more parts or components. A first part or component of the codebook may include bundled HARQ feedback. A second part or component of the codebook may include more granular (e.g., more granular than the first part or component of the codebook) HARQ feedback. The granularity of the first or second part of the codebook may be at a CBG level, a TB level, a bundled TB level (e.g., multiple TBs bundled together), or a time period level (e.g., allocations in a set of time periods or slots, bundled together). For example, the WTRU may be configured to report TB-level HARQ feedback in the first part of the codebook and report CBG-level HARQ feedback in a second part of the codebook. As another example, the WTRU may be configured to report bundled TB HARQ feedback (e.g., HARQ feedback for a set of TBs) in the first part of the codebook and report TB-level HARQ feedback in the second part of the codebook.

One or more elements in the second part or component of the HARQ codebook may be associated with an element in the first part or component of the HARQ codebook. For example, the first part of the HARQ codebook may provide TB-level HARQ feedback, the second part of the HARQ codebook may provide CBG-level HARQ feedback, and a (e.g., each) TB-level HARQ element in the first part or component of the HARQ codebook may be associated with a set of CBG-level HARQ-ACK elements in the second part or component of the HARQ codebook. If an ACK is determined for a TB in the first part or component of the HARQ codebook, an ACK may also be determined for one or more (e.g., all) CBGs associated with the TB in the second part or component of the HARQ codebook. If an NACK is determined for the TB in a first part or component of HARQ codebook, then the second part or component of the HARQ codebook may include an NACK for at least one CBG associated with the TB.

The WTRU may select or determine a bundling granularity for the first or second part or component of the HARQ codebook. The WTRU may determine the bundling granularity based on (e.g., as a function of) at least one of a feedback overhead reduction requirement, a feedback performance requirement, a channel condition, a HARQ-ACK operating point, a feedback latency, a retransmission latency, or previous performance of the WTRU. With respect to the feedback overhead reduction requirement, the WTRU may select the bundling granularity for the first or second part of the HARQ codebook to minimize the feedback overhead (e.g., by using the largest achievable bundling granularity). With respect to the feedback performance requirement, the WTRU may select a bundling granularity that may reduce unnecessary retransmissions. With respect to the channel condition, the WTRU may select a bundling granularity based on (e.g., as a function of) a measured (e.g., currently measured) or predicted channel condition. For example, the WTRU may determine or predict that a set of subsequent slots may experience similar channel conditions and/or HARQ-ACK performance. As a result, the WTRU may bundle transmissions in that set of slots into a single feedback element. With respect to the HARQ-ACK operating point, the WTRU may select a bundling granularity based on (e.g., as a function of) an expected rate of NACKs. With respect to the feedback latency, the WTRU may select a bundling granularity based on a permissible latency to deliver the feedback. With respect to the retransmission latency, the WTRU may select a bundling granularity based on the timing of a feedback report and/or a retransmission latency provided by the network or an application. With respect to the previous performance of the WTRU, the WTRU may select a bundling granularity based on the feedback performance of a previously selected bundling granularity, wherein the feedback performance may be measured based on a retransmission latency, a feedback latency, a rate or number of unnecessary retransmissions, and/or overhead associated with the feedback.

A WTRU may determine or be triggered to use or stop using the new or enhanced HARQ codebook described herein. The triggers may include at least one of an indication from a base station, a prediction of future HARQ transmissions by the WTRU, a transmission requirement, or a HARQ reporting requirement. The indication from the base station may be received by the WTRU via RRC signaling, a MAC CE, or DCI. The indication may be implicit (e.g., indicated by the use of multiple resources each associated with a part or component of the codebook, or by the assignment of a non-numeric or invalid feedback resource). The indication may indicate time-frequency or spatial resources, a BWP or carrier with which the indication is associated, etc. With respect to the prediction of future HARQ-ACK transmissions, the WTRU may determine that future HARQ-ACK/NACK performance may be stable and thus the WTRU may use bundling or a specific bundling granularity. With respect to the transmission requirement, the WTRU may determine, based on latency and/or a BLER, whether or not to use the HARQ codebook described herein. For example, the WTRU may determine the type of HARQ codebook to use (e.g., enhanced or legacy) based on (e.g., as a function of) the priority of a transmission. With respect to the HARQ reporting requirement, the WTRU may determine to use the HARQ codebook described herein based on (e.g., as a function of) a HARQ operating point, a latency requirement, and/or the like.

The WTRU may indicate to a base station one or more parameters associated with the enhanced HARQ codebook described herein. For example, the WTRU may indicate to the base station when the HARQ codebook may be used or when the HARQ codebook may not be used. The WTRU may send a request to the base station to use or stop using the HARQ codebook. The indication or request may be accomplished using dedicated resources, via a CSI report, via a MAC CE, and/or via a previous HARQ feedback report. With respect to the dedicated resources, the WTRU may be configured with resources dedicated to reporting parameters (or an update thereof) associated with the HARQ codebook. For example, the WTRU may be configured with resources dedicated to reporting the use or non-use of the HARQ codebook. With respect to the CSI report, the WTRU may indicate, in the CSI report, a request to use or stop using the HARQ codebook. The WTRU may also indicate the parameters associated with the HARQ codebook in the CSI report. With respect to the previous HARQ feedback report, the WTRU may indicate, in that HARQ feedback report, the parameters associated with the HARQ codebook to be transmitted subsequently or an indication/request to use or stop using the HARQ codebook for a subsequent HARQ feedback report. The indication sent by the WTRU to the base station may indicate time-frequency or spatial resources, carrier(s), or BWP(s) for which the indication may be valid.

The contents of a part or component of the HARQ codebook described herein may depend on the contents of another part or component of the HARQ codebook. For example, the first part or component of the HARQ codebook may indicate a set of ACKs or NACKs at a first granularity level (e.g., TB-based ACK/NACK), and that granularity level may be used to determine a granularity level for the second part or component of the HARQ codebook (e.g., CBG-based ACK/NACK, wherein the CBGs may be associated with a TB of the first part or component of the HARQ codebook). The WTRU may include, in the second part or component of the HARQ codebook, HARQ feedback for a set of units (e.g., CBGs) that may be associated with a set of units (e.g., a TB) NACKed in the first part or component of the HARQ codebook. For example, the first part or component of the HARQ codebook may include HARQ feedback for a bundle of TBs, and the second part or component of the HARQ codebook may include HARQ feedback for individual TBs. In this example, a first element of the first part or component of the HARQ codebook may represent a HARQ-ACK/NACK for first x bundled TBs and a second element of the first part or component of the HARQ codebook may represent a HARQ-ACK/NACK for second x bundled TBs. If the first element is an ACK and the second element is an NACK, the WTRU may determine that the second part or component of the HARQ codebook may include (e.g., may only include) HARQ-ACK/NACK for TBs that are among the second set of x TBs (e.g., which are NACKed in the first part of the HARQ codebook). As another example, if a WTRU is not triggered to report the first part or component of the HARQ codebook but is triggered to report the second part or component of the HARQ codebook, the WTRU may report HARQ feedback information (e.g., all elements) from the second part or component of the HARQ codebook, regardless of the unreported HARQ feedback (e.g., from the first part or component of the HARQ codebook).

A WTRU may be configured with resources to report one or multiple parts or components of the HARQ codebook described herein. The WTRU may determine the resources for transmitting a second part or component of the HARQ codebook based on (e.g., as a function of) the contents of a first part or component of the HARQ codebook. The WTRU may be configured with resources to transmit the first part or component of the HARQ codebook (e.g., the first part or component of the HARQ codebook may include one or more elements based on a first bundling granularity). The WTRU may be configured with resources to transmit the second part or component of the HARQ codebook that may be associated with the first part or component of the HARQ codebook. For example, the WTRU may be configured to report n (e.g., consecutive) first component HARQ codebooks and, with a (n+1)th reporting resource, the WTRU may include a (n+1)th first component HARQ codebook and a second component HARQ codebook that may be associated with one of the first n component HARQ codebooks or the (n+1)th first component HARQ codebook. As another method, the WTRU may be configured with a resource for the first part or component of the HARQ codebook (e.g., via a k1 value in a DCI or a first PUCCH feedback resource) and a resource for the second part or component of the codebook (e.g., via a k1′ value in a DCI or a second PUCCH feedback resource). The resources (e.g., indicated by the k1 or k1′ value) may have a non-numeric or invalid value, in which case the WTRU may store the corresponding part or component of the HARQ codebook until the WTRU is triggered (or polled) to transmit it by the base station. The WTRU may determine an index associated with a part or component of the HARQ codebook and may be triggered to report the part or component of the codebook via an indication (e.g., in DCI) that may include the index.

If the WTRU is indicated (e.g., triggered) by the base station to report a second part or component of the HARQ codebook whose contents or size may depend on a first part or component of the HARQ codebook, the indication may also include an expected size of the second part or component of the codebook. This may ensure common understanding by the base station and the WTRU with respect to the contents of the second part or component of the codebook. If the indicated size of the second part or component of the codebook is not a value expected by the WTRU, the WTRU may report an error, report the second part or component of the codebook up to the size indicated, or report a complete second part or component of the codebook (e.g., independent of the contents of the first part or component of the codebook).

The terms “HARQ codebook,” “HARQ-ACK codebook,” “HARQ-ACK/NACK codebook,” “HARQ-ACK codebook type x,” “new HARQ codebook” and “enhanced HARQ codebook” may be used interchangeably herein.

A WTRU may receive configuration information regarding a one-shot transmission of the HARQ codebook described herein from a base station. The WTRU may assume that the one-shot HARQ codebook transmission is activated by default if the WTRU is configured with the one-shot transmission). In one example approach, the WTRU may start performing the one-shot HARQ codebook transmission upon being configured. In another example approach, the WTRU may wait for a subsequent activation indication from the base station before starting to perform the one-shot HARQ codebook transmission. The subsequent activation indication from the base station may trigger the WTRU to apply the configuration associated with one-shot HARQ codebook transmission.

The WTRU may be configured to perform one or more of the actions described herein upon applying/activating the configuration associated with the one-shot HARQ codebook transmission. The WTRU may receive a grant or configuration for reception of a PDCCH, an SPS-PDSCH, a TCI state update, etc. The WTRU may receive a dynamic grant for a PDSCH. The grant or configuration may include corresponding HARQ-ACK/NACK parameters, including a HARQ process ID, a HARQ codebook type, a type of spatial bundling, a code block group (CBG) transmission, etc. The WTRU may receive scheduled DL data and may determine corresponding HARQ feedback according to the HARQ codebook described herein. For example, the WTRU may buffer and/or store a TB-based HARQ bitmap (e.g., as a first part of the HARQ codebook) and/or CBG-based HARQ feedback (e.g., as a second part of the HARQ codebook). While performing these actions, the WTRU may not transmit a legacy HARQ codebook and may assume that PUCCH resources for legacy HARQ transmission may be deactivated or unavailable.

Triggers may be configured for deactivating or stopping the use of the HARQ codebook described herein. A WTRU may be configured to determine (e.g., autonomously) one or more behaviors that may be associated with the buffering of the HARQ codebook described herein for a one-shot HARQ codebook transmission. For example, the WTRU may be configured to determine if the buffering of the HARQ codebook for a one-shot HARQ codebook transmission should be deactivated. The WTRU may be configured with conditions to trigger the activation/deactivation of the one-shot HARQ codebook transmission. For example, the WTRU may trigger the deactivation of the one-shot transmission based on (e.g., as a function of) a buffer status of the WTRU. As another example, the WTRU may trigger the deactivation of the one-shot transmission if a remaining buffer (e.g., soft buffer) size of the WTRU is below a preconfigured threshold. As yet another example, the WTRU may trigger the deactivation of the one-shot transmission if the remaining buffer (e.g., soft buffer) of the WTRU is not enough to accommodate data associated with DL transmissions. One or more of these determinations may be made based on (e.g., as a function of) the WTRU's capabilities.

In examples, the WTRU may trigger the deactivation of the one-shot HARQ transmission based on (e.g., as a function of) a Round-Trip Time (RTT). The WTRU may be configured with maximum, acceptable, or allowable RTTs, for example, as a function of different service requirements. The WTRU may trigger a deactivation of the one-shot HARQ transmission if the RTT of the oldest buffered HARQ process exceeds a configured RTT threshold. The WTRU may trigger the deactivation if a preconfigured number of HARQ processes have RTTs that exceed a configured RTT threshold. The threshold(s) may be configured such that the WTRU may recover from a condition where the delaying of HARQ transmissions (e.g., for feedback overhead reduction) may lead to an increased RTT that may negatively affect the quality of service.

The WTRU may be configured to determine one or more behaviors associated with the one-shot transmission of the HARQ codebook described herein based on the output of an AI/ML model. For example, the WTRU may be configured with an AI/ML model to predict the probability of successful decoding at a future time instance. The AI/ML model may predict the probability of a number of consecutive ACKs in a future time interval being below a threshold. The WTRU may determine the probability of a number of NACKs in a future interval being above a threshold. The WTRU may determine the optimal HARQ codebook type (e.g., the codebook described herein or a legacy codebook) to apply based on predicted channel conditions at a future time instance. The WTRU may deactivate the use of the HARQ codebook described herein based on the output of the AI/ML model. For example, the WTRU may infer from a prediction output of the AI/ML model that the HARQ codebook may lead to increased delay and the WTRU may trigger the deactivation accordingly. The inputs to the AI/ML model described herein may be configured. For example, the WTRU may input the current and/or historical channel measurements (e.g., including but not limited to a raw channel matrix, eigenvector(s) of a channel, CSI, RSRP, RSRQ, SINR, etc.), WTRU speed/doppler, current and/or historical BLER, ACK/NACK, HARQ buffer status, configuration aspects of one-short transmissions of HARQ feedback, the HARK-ACK codebook described herein, etc.

The term “deactivation indication” and “deactivation request” may be used interchangeably herein. If one or more trigger conditions for deactivation of the HARQ-ACK codebook described herein are satisfied, the WTRU may indicate or send a request to the base station to deactivate or stop the buffering of the HARQ feedback. The WTRU may be configured to transmit the deactivation indication using one or more of the following methods. In a first example, the WTRU may transmit the deactivation indication using one or more preconfigured bits in a CSI report. For example, the WTRU may include a flag in the CSI report to indicate a deactivation request for the HARQ-ACK codebook or the one-shot transmission of the HARQ codebook. The deactivation indication may be carried in any part of the CSI report. The WTRU may be configured with SR-PUCCH resources dedicated for the transmission of the deactivation indication. The WTRU may, based on the satisfaction of one or more trigger conditions described herein, transmit the deactivation indication in the configured SR-PUCCH resources.

The WTRU may be configured to transmit the deactivation indication in the earliest occurring UL opportunity. For example, the WTRU may transmit the deactivation indication in a PUSCH resource if it occurs earlier than a PUCCH resource, a CSI reporting resource, or an SR resource. The WTRU may transmit the deactivation indication in a MAC CE.

The WTRU may be configured to deactivate one-shot transmission of the HARQ-ACK codebook described herein based on an indication from the base station. For example, the WTRU may be configured to deactivate the one-shot HARQ transmission upon receiving a PDCCH with a valid value of K1. Upon the deactivation of the one-shot transmission, the WTRU may stop buffering HARQ feedback associated with the HARQ codebook and transmit the stored/buffered HARQ codebook using a PUCCH resource. After the transmission, the WTRU may resume the buffering of HARQ feedback associated with the HARQ-ACK codebook (e.g., the deactivation from the base station may be one-shot). The WTRU may use PUCCH resources for a legacy HARQ codebook or legacy HARQ feedback upon deactivation of the HARQ codebook described herein.

The WTRU may treat a deactivation indication from the base station as semi-static. For example, in response to receiving deactivation indication, the WTRU may suspend the use of the HARQ codebook described herein and use a legacy HARQ codebook for subsequent HARQ feedback. The WTRU may resume using the HARQ codebook described herein upon receiving an indication (e.g., an explicit indication) from the base station, such as, for example, an invalid/predefined K1 value in DCI and/or a MAC CE.

The WTRU may receive a grant and/or activation of a UL resource for transmitting the HARQ codebook described herein. Such a grant or activation of the UL resource may be signaled along with a deactivation indication from the base station. Upon receiving such a grant or activation, the WTRU may perform a one-shot transmission of the HARQ codebook generated/buffered thus far (e.g., before the deactivation indication) to the base station using one or more of the methods described herein.

A WTRU may perform a one-shot transmission of the HARQ codebook described herein (e.g., a new or enhanced HARQ codebook). The WTRU may enable/disable, use/stop using, or activate/deactivate a HAORP (e.g., based on an AI/ML model, a measurement, or an explicit indication from a base station). If the HAORP enablement/disablement decision is made by the WTRU, the WTRU may send an indication to the base station regarding the decision (e.g., via a CSI report or a HARQ-ACK/NACK transmission). The WTRU may, for example, send a flag or indication to the base station requesting enablement of a one-shot transmission of the HARQ codebook. The WTRU may also indicate to the base station the carrier for which the HAORP is requested. If the HAORP decision is made by the base station, the WTRU may receive an indication from the base station to enable (or disable) the HAORP. The indication may indicate a carrier to which the HAORP may be related. The indication may be provided explicitly, e.g., via a reserved field in DCI, to inform the WTRU that the base station has accepted the HAORP request. The indication may be provided implicitly, e.g., via a PUCCH resource indicator or a K1 value. For example, a PUCCH resource indicator of O may indicate that no PUCCH resource has been allocated for HARQ and/or that the base station has accepted a one-shot HARQ feedback transmission. An invalid K1 value may also indicate that the base station has accepted the one-shot HARQ feedback transmission.

The WTRU may receive scheduling information to enable reception of one or more transmissions for which the WTRU may report a HARQ-ACK/NACK. The scheduling information may include one or more K1 values. If the WTRU is scheduled with a single K1 value, the WTRU may determine the resources with which to report the HARQ-ACK/NACK for the scheduled one or more transmissions based on the value of K1. If the WTRU is scheduled with two K1 values, the WTRU may determine the resources with which to report a first set of HARQ-ACK/NACK bits based on the first K1 value, and determine the resources with which to report a second set of HARQ-ACK/NACK bits based on the second K1 value.

The WTRU may build a two-part HARQ codebook (e.g., a first set of HARQ bits corresponding to TB-based HARQ of one or more received transmissions, and a second set of HARQ bits corresponding to CBG-based HARQ for at least a subset of the one or more received transmissions). The WTRU may report the first set of HARQ bits using resources determined from a first K1 value. The WTRU may report the second set of HARQ bits using resources determined from the first K1 value (e.g., if the WTRU is scheduled with a single K1 value), or resources determined from a second K1 value (e.g., if the WTRU is scheduled with a second K1 value with a numeric or valid value). The WTRU may keep the second set of HARQ bits in a buffer (e.g., if the WTRU is scheduled with a non-numeric or invalid K1 value). If the WTRU buffers the second set of HARQ bits, the WTRU may determine whether to provide feedback associated with the second set of HARQ bits based on an AI/ML model, a measurement, a buffer size, and/or a round-trip time (RTT). With the AI/ML model, the WTRU may predict and/or determine (e.g., based on an indication from a base station) that a situation with consecutive ACKs may no longer be possible and/or that the number of NACKs may be increasing. With the buffer size, the WTRU may determine that its buffer space may be limited. With the RTT, the WTRU may determine that a further delay of the HARQ transmission may exceed a configured RTT (e.g., a maximum RTT). The WTRU may transmit a request to report the second set of HARQ bits, for example, via a scheduling request.

Although features and elements described above are described in particular combinations, each feature or element may be used alone without the other features and elements of the preferred embodiments, or in various combinations with or without other features and elements. Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

1. A wireless transmit/receive unit (WTRU), comprising:
a processor configured to:
transmit a first type of hybrid automatic repeat request (HARQ) feedback to a network device;
determine that a condition for using a second type of HARQ feedback is met, wherein the determination is based on a measurement or prediction made by the WTRU;
send a first message to the network device, wherein the first message indicates that the condition for switching to the second type of HARQ feedback is met;
receive a second message from the network device, wherein the second message includes an indication for the WTRU to use the second type of HARQ feedback; and
transmit a HARQ feedback of the second type based on the second message received from the network device.

2. The WTRU of claim 1, wherein the first type of HARQ feedback includes a transport block (TB) based HARQ feedback, and wherein the second type of HARQ feedback includes a code block group (CBG) based HARQ feedback or a hybrid of TB-based and CBG-based HARQ feedback.

3. The WTRU of claim 1, wherein the condition is associated with at least one of a reference signal received power (RSRP), a signal to noise ratio (SNR), or a channel quality indicator (CQI) measured or predicted by the WTRU based on a reference signal.

4. The WTRU of claim 1, wherein the first message includes a channel state information (CSI) report.

5. The WTRU of claim 4, wherein the CSI report includes a measurement result that indicates that the condition for switching to the second type of HARQ feedback is met.

6. The WTRU of claim 1, wherein the first message further indicates a time duration for using the second type of HARQ feedback.

7. The WTRU of claim 1, wherein the second message is received by the WTRU via downlink control information or a medium access control (MAC) control element (CE).

8. The WTRU of claim 1, wherein the second message further indicates a time duration for using the second type of HARQ feedback.

9. The WTRU of claim 8, wherein the processor is further configured to determine that the time duration for using the second type of HARQ feedback has expired and send a third message to the network device that indicates that the time duration has expired.

10. The WTRU of claim 1, wherein the processor is further configured to determine that the condition for using the second type of HARQ feedback is no longer valid and send a third message to the network device that indicates that the condition for using the second type of HARQ feedback is no longer valid.

11. A method implemented by a wireless transmit/receive unit (WTRU), the method comprising:
transmitting a first type of Hybrid Automatic Repeat Request (HARQ) feedback to a network device;
determining that a condition for switching to a second type of HARQ feedback is met, wherein the determination is based on a measurement or prediction made by the WTRU;
sending a first message to the network device, wherein the first message indicates that the condition for switching to the second type of HARQ feedback is met;
receiving a second message from the network device, wherein the second message includes an indication for the WTRU to use the second type of HARQ feedback; and
transmitting a HARQ feedback of the second type based on the second message received from the network device.

12. The method of claim 11, wherein the first type of HARQ feedback includes a transport block (TB) based HARQ feedback, and wherein the second type of HARQ feedback includes a code block group (CBG) based HARQ feedback or a hybrid of TB-based and CBG-based HARQ feedback.

13. The method of claim 11, wherein the condition is associated with at least one of a reference signal received power (RSRP), a signal to noise ratio (SNR), or a channel quality indicator (CQI) measured or predicted by the WTRU based on a reference signal.

14. The method of claim 11, wherein the first message includes a channel state information (CSI) report.

15. The method of claim 14, wherein the CSI report includes a measurement result that indicates that the condition for switching to the second type of HARQ feedback is met.

16. The method of claim 11, wherein the first message further indicates a time duration for using the second type of HARQ feedback.

17. The method of claim 11, wherein the second message is received by the WTRU via downlink control information or a medium access control (MAC) control element (CE).

18. The method of claim 11, wherein the second message further indicates a time duration for using the second type of HARQ feedback.

19. The method of claim 17, further comprising determining that the time duration for using the second type of HARQ feedback has expired and sending a third message to the network device that indicates that the time duration has expired

20. The method of claim 11, further comprising determining that the condition for using the second type of HARQ feedback is no longer valid and sending a third message to the network device that indicates that the condition for using the second type of HARQ feedback is no longer valid.
